(19) United States
(12) Patent Application Publication
(10) Pub. No.: US 2025/0313505 A1
(43) Pub. Date: Oct. 9, 2025

(54) OPTICAL GLASS AND OPTICAL ELEMENT

(71) Applicants: HOYA CORPORATION, Tokyo (JP); HOYA OPTICAL TECHNOLOGY (WEIHAI) CO., LTD., ShanDong (CN)

(72) Inventors: Shohei KINEZUKA, Tokyo (JP); Tomoaki NEGISHI, Tokyo (JP)

(73) Assignees: HOYA CORPORATION, Tokyo (JP); HOYA OPTICAL TECHNOLOGY (WEIHAI) CO., LTD., ShanDong (CN)

(21) Appl. No.: 19/074,594

(22) Filed: Mar. 10, 2025

(30) Foreign Application Priority Data
Mar. 14, 2024 (JP) 2024-040244
Jan. 21, 2025 (JP) 2025-008375

(51) Int. Cl. C03C 3/064; G02B 27/01

(52) U.S. Cl. CPC C03C 3/064; G02B 27/0172; G02B 27/0176; C03C 2203/10; G02B 2027/0178

(57) ABSTRACT

There is provided an optical glass in which an amount of SiO₂ is 5% by mass or more, an amount of B₂O₃ is 15% by mass or less, a total amount of Li₂O, Na₂O, and K₂O [Li₂O+Na₂O+K₂O] is 1 to 15% by mass, a mass ratio of an amount of Li₂O to the total amount of Li₂O, Na₂O, and K₂O [Li₂O/(Li₂O+Na₂O+K₂O)] is 0.5 or less, a mass ratio of an amount of K₂O to the total amount of Li₂O, Na₂O, and K₂O [K₂O/(Li₂O+Na₂O+K₂O)] is 0.5 or less, a mass ratio of the total amount of Li₂O, Na₂O, and K₂O to a total amount of MgO, CaO, SrO, and BaO [(Li₂O+Na₂O+K₂O)/(MgO+CaO+SrO+BaO)] is 0.6 or less, an amount of TiO₂ is 15% by mass or more, an amount of Nb₂O₅ is 1 to 30% by mass, a mass ratio of the amount of SiO₂ to the amount of TiO₂ [SiO₂/TiO₂] is 1.0 or less, the total amount of MgO, CaO, SrO, and BaO [MgO+CaO+SrO+BaO] is 5% by mass or more, a mass ratio of an amount of BaO to the total amount of MgO, CaO, SrO, and BaO [BaO/(MgO+CaO+SrO+BaO)] is 0.7 or less, a total amount of TiO₂ and Nb₂O₅ [TiO₂+Nb₂O₅] is 30% by mass or more, and a mass ratio of the amount of TiO₂ to a total amount of TiO₂, Nb₂O₅, Y₂O₃, ZrO₂, La₂O₃, Gd₂O₃, Ta₂O₅, WO₃, Yb₂O₃, and Bi₂O₃ [TiO₂/(TiO₂+Nb₂O₅+Y₂O₃+ZrO₂+La₂O₃+Gd₂O₃+Ta₂O₅+WO₃+Yb₂O₃+Bi₂O₃)] is 0.6 or more.

### BACKGROUND OF THE INVENTION

The present invention relates to an optical glass and an optical element.

In recent years, with the advancement of augmented reality (AR), mixed reality (MR), and virtual reality (VR) technologies, for example, goggle type or eyeglass type display devices have been developed as AR devices, MR devices, and VR devices. For example, the goggle type display devices require a lens having a high refractive index and a low specific gravity, and there is an increasing demand for glass applicable to such a lens. However, at present, in order to achieve the properties of a high refractive index and a low specific gravity, a glass component which has a high raw material cost, such as Nb or Li, is used in the glass applicable to such a lens. Therefore, an increase in raw material costs has become a problem.

Patent Document 1 discloses an optical glass having a high refractive index. However, in order to adopt the optical glass of Patent Document 1 for a lens used in an AR device or the like, the optical glass contains a large amount of a glass component in which the specific gravity is large with respect to the refractive index and which has a high raw material cost, such as Nb or Li.

Therefore, an optical glass in which the specific gravity and the raw material costs can be reduced while a high refractive index is maintained is required.
Patent Document 1: WO 2021/171950 A

### BRIEF SUMMARY OF THE INVENTION

The present invention has been made in view of such circumstances, and an object of the present invention is to provide an optical glass and an optical element in which the specific gravity is reduced and the raw material costs are reduced while a high refractive index is maintained.

The concept of the present invention is as follows.
(1) An optical glass,
wherein an amount of SiO₂ is 5% by mass or more,
an amount of B₂O₃ is 15% by mass or less,
a total amount of Li₂O, Na₂O, and K₂O [Li₂O+Na₂O+K₂O] is 1 to 15% by mass,
a mass ratio of an amount of Li₂O to the total amount of Li₂O, Na₂O, and K₂O [Li₂O/(Li₂O+Na₂O+K₂O)] is 0.5 or less,
a mass ratio of an amount of K₂O to the total amount of Li₂O, Na₂O, and K₂O [K₂O/(Li₂O+Na₂O+K₂O)] is 0.5 or less,
a mass ratio of the total amount of Li₂O, Na₂O, and K₂O to a total amount of MgO, CaO, SrO, and BaO [(Li₂O+Na₂O+K₂O)/(MgO+CaO+SrO+BaO)] is 0.6 or less,
an amount of TiO₂ is 15% by mass or more,
an amount of Nb₂O₅ is 1 to 30% by mass,
a mass ratio of the amount of SiO₂ to the amount of TiO₂ [SiO₂/TiO₂] is 1.0 or less,
the total amount of MgO, CaO, SrO, and BaO [MgO+CaO+SrO+BaO] is 5% by mass or more,
a mass ratio of an amount of BaO to the total amount of MgO, CaO, SrO, and BaO [BaO/(MgO+CaO+SrO+BaO)] is 0.7 or less,
a total amount of TiO₂ and Nb₂O₅ [TiO₂+Nb₂O₅] is 30% by mass or more,
a mass ratio of the amount of TiO₂ to a total amount of TiO₂, Nb₂O₅, Y₂O₃, ZrO₂, La₂O₃, Gd₂O₃, Ta₂O₅, WO₃, Yb₂O₃, and Bi₂O₃ [TiO₂/(TiO₂+Nb₂O₅+Y₂O₃+ZrO₂+La₂O₃+Gd₂O₃+Ta₂O₅+WO₃+Yb₂O₃+Bi₂₀₃)] is 0.6 or more.
(2) An optical element comprising the optical glass according to (1) above.
(3) A light guide plate comprising the optical glass according to (1) above.

According to the present invention, there is provided the optical glass and the optical element in which the specific gravity is reduced and the raw material costs are reduced while a high refractive index is maintained.

### DETAILED DESCRIPTION OF THE INVENTION

In the present invention and this specification, a glass composition is expressed on an oxide basis unless otherwise specified. Here, the “glass composition on an oxide basis” refers to a glass composition obtained by conversion under the assumption that glass raw materials are completely decomposed during melting and are present as oxides in the glass, and the notation of each glass components follows the convention and is expressed as SiO₂, TiO₂, or the like. The amount and total amount of the glass components are based on mass unless otherwise specified, and “%” means “% by mass”.

The amount of the glass components can be quantified by a known method, for example, inductively coupled plasma atomic emission spectroscopy (ICP-AES), inductively coupled plasma mass spectrometry (ICP-MS), or the like. In addition, in this specification and the present invention, the amount of a constituent component being 0% means that the constituent component is substantially not contained, and the component is permitted to be contained at an inevitable impurity level.

In this specification, both the thermal stability and the reheat stability of glass refer to the resistance to crystal precipitation in the glass. Particularly, the thermal stability refers to the resistance to crystal precipitation when glass in a molten state solidifies, and the reheat stability refers to the resistance to crystal precipitation when solidified glass is reheated, such as during reheat pressing.

Unless otherwise specified, the refractive index refers to a refractive index nd at the d-line of helium (wavelength 587.56 nm).

An Abbe number vd is used as a value representing the properties related to dispersion, and is expressed by the following equation. Here, np is the refractive index at the F-line of blue hydrogen (wavelength 486.13 nm), and ne is the refractive index at the C-line of red hydrogen (656.27 nm).

$$vd = ( nd - 1 ) / ( {n}_{F} - {n}_{C} )$$

Hereinafter, one embodiment of the present invention will be described.

In an optical glass according to the present embodiment, the amount of SiO₂ is 5% or more. The lower limit of the amount of SiO₂ is preferably 5.0%, and more preferably 6.0%, 8.0%, 10.0%, 12.0%, 14.0%, 16.0%, 17.0%, 18.0%, 19.0%, and 20.0% in order. In addition, the upper limit of the amount of SiO₂ is preferably 30.0%, and more preferably 29.0%, 28.0%, 27.0%, 26.0%, 25.0%, and 24.0% in order.

SiO₂ is a network-forming component of the glass, and has a function of improving the thermal stability, chemical durability, and weather resistance of the glass and increasing the viscosity of the molten glass. When the amount of SiO₂ is too low, the devitrification resistance of the glass tends to decrease. When the amount of SiO₂ is too high, the refractive index nd may decrease.

In the optical glass according to the present embodiment, the amount of B₂O₃ is 15% or less. The upper limit of the amount of B₂O₃ is preferably 15.0%, and more preferably 13.0%, 10.0%, 9.0%, 8.0%, 7.0%, 6.0%, and 5.0% in order. The lower limit of the amount of B₂O₃ is preferably 0.0%, and more preferably 1.0%, 2.0%, and 3.0% in order.

B₂O₃ has a function of improving the thermal stability of the glass and increasing the meltability of the glass. In addition, among the network-forming components of the glass, B₂O₃ is a component relatively capable of increasing the refractive index and reducing the specific gravity. An optical glass in which the meltability of the glass is improved, the refractive index is high, and the specific gravity is reduced can be obtained by setting the amount of B₂O₃ in the above-described range. Meanwhile, when the amount of B₂O₃ is too low, the high refractive index property may be impaired and the specific gravity may increase. In addition, when the amount of B₂O₃ is too high, the amount of volatilization of the glass components during melting of the glass may increase.

In the optical glass according to the present embodiment, the total amount of Li₂O, Na₂O, and K₂O [Li₂O+Na₂O+K₂O] is 1 to 15%. The lower limit of the total amount is preferably 1.0%, and more preferably 2.0%, 3.0%, and 4.0% in order. In addition, the upper limit of the total amount is preferably 10%, and more preferably 9.0%, 8.0%, and 7.0% in order.

By setting the total amount [Li₂O+Na₂O+K₂O] in the above-described range, the viscosity of the glass can be appropriately maintained, and the productivity of the glass can be increased. In addition, the internal transmittance at 460 nm can be increased by suppressing light absorption caused by reduction components derived from Ti and Nb, and promoting the elimination of electronic defects in the glass caused by a decrease in melting temperature or slow cooling. Meanwhile, when the total amount is too low, the meltability of the glass raw materials may deteriorate, and the melting temperature of the raw materials may need to be set higher. When the total amount is too high, the viscosity of the glass may decrease, and accordingly, a decrease in thermal stability may occur, so that the productivity may deteriorate. In addition, the resistivity of the molten glass may decrease, and the heating efficiency when molten glass is heated by being energized may decrease, and as a result, the meltability of the glass may decrease and the productivity may decrease.

In the optical glass according to the present embodiment, the mass ratio of the amount of Li₂O to the total amount of Li₂O, Na₂O, and K₂O [Li₂O/(Li₂O+Na₂O+K₂O)] is 0.5 or less. The upper limit of the mass ratio is preferably 0.50, and more preferably 0.40, 0.30, 0.20, and 0.10 in order. In addition, the lower limit of the mass ratio is preferably 0.00, and more preferably 0.01 and 0.02 in order. An optical glass in which the refractive index is high, the specific gravity is reduced, and the raw material costs are reduced can be obtained by setting the mass ratio in the above-described range.

In the optical glass according to the present embodiment, the mass ratio of the amount of K₂O to the total amount of Li₂O, Na₂O, and K₂O [K₂O/(Li₂O+Na₂O+K₂O)] is 0.5 or less. The upper limit of the mass ratio is preferably 0.40, and more preferably 0.35 and 0.30 in order. In addition, the lower limit of the mass ratio is preferably 0.00, and more preferably 0.05, 0.10, and 0.15 in order. An optical glass in which the refractive index is high and the specific gravity is reduced can be obtained by setting the mass ratio in the above-described range.

In the optical glass according to the present embodiment, the mass ratio of the total amount of Li₂O, Na₂O, and K₂O to the total amount of MgO, CaO, SrO, and BaO [(Li₂O+Na₂O+K₂O)/(MgO+CaO+SrO+BaO)] is 0.6 or less. The upper limit of the mass ratio is preferably 0.50, and more preferably 0.45, 0.40, 0.35, and 0.30 in order. In addition, the lower limit of the mass ratio is preferably 0.05, and more preferably 0.10, 0.15, and 0.20 in order.

An optical glass in which the specific gravity is reduced can be obtained by setting the mass ratio [(Li₂O+Na₂O+K₂O)/(MgO+CaO+SrO+BaO)] in the above-described range. In addition, the reduction color of the glass can be suppressed, so that the internal transmittance can be improved. Meanwhile, when the mass ratio is too small, the meltability of the glass may deteriorate. In addition, when the mass ratio is too large, the glass components are likely to volatilize during melting, and the viscosity of the molten glass may decrease, so that the thermal stability may decrease.

In the optical glass according to the present embodiment, the amount of TiO₂ is 15% or more. The lower limit of the amount of TiO₂ is preferably 20.0%, and more preferably 22.0%, 24.0%, 26.0%, and 28.0% in order. In addition, the upper limit of the amount of TiO₂ is preferably 60.0%, and more preferably 55.0%, 50.0%, 45.0%, 40.0%, 38.0%, and 36.0% in order.

An optical glass in which the refractive index is high and the specific gravity is reduced can be obtained by setting the amount of TiO₂ in the above-described range. Meanwhile, when the amount of TiO₂ is too low, the refractive index may decrease and the specific gravity may increase. In addition, when the amount of TiO₂ is too high, the internal transmittance of the glass in the visible range, particularly in the short wavelength range, may decrease, and the devitrification resistance may also decrease.

In the optical glass according to the present embodiment, the amount of Nb₂O₅ is 1 to 30%. The lower limit of the amount of Nb₂O₅ is preferably 1.0%, and more preferably 1.5%, 2.0%, 2.5%, and 3.0% in order. In addition, the upper limit of the amount of Nb₂O₅ is preferably 20.0%, and more preferably 18.0%, 16.0%, 14.0%, 12.0%, and 10.0% in order.

An optical glass in which the refractive index is high, the raw material costs are reduced, and the thermal stability of the glass is improved can be obtained by setting the amount of Nb₂O₅ in the above-described range. Meanwhile, when the amount of Nb₂O₅ is too low, the refractive index may decrease. When the amount of Nb₂O₅ is too high, the devitrification resistance may decrease.

In the optical glass according to the present embodiment, the mass ratio of the amount of SiO₂ to the amount of TiO₂ [SiO₂/TiO₂] is 1.0 or less. The upper limit of the mass ratio is preferably 0.80, and more preferably 0.75, 0.70, 0.65, and 0.60 in order. In addition, the lower limit of the mass ratio is preferably 0.20, and more preferably 0.25, 0.30, 0.35, and 0.40 in order.

An optical glass in which the refractive index is high and the specific gravity is reduced can be obtained by setting the mass ratio [SiO₂/TiO₂] in the above-described range. In addition, the thermal stability of the glass can be improved, and the meltability of the glass can be increased.

In the optical glass according to the present embodiment, the total amount of MgO, CaO, SrO, and BaO [MgO+CaO+SrO+BaO] is 5% or more. The lower limit of the total amount is preferably 15.0%, and more preferably 16.0%, 17.0%, and 18.0% in order. In addition, the upper limit of the total amount is preferably 40.0%, and more preferably 38.0%, 36.0%, 34.0%, 32.0%, and 30.0% in order.

By setting the total amount [MgO+CaO+SrO+BaO] in the above-described range, the meltability of the glass can be improved, and the thermal stability of the glass can be increased. Meanwhile, when the total amount is too low, the meltability of the glass may deteriorate, and the erosion of refractory bricks during melting of the glass may increase. In addition, when the total amount is too high, desired optical properties may not be obtained and the thermal stability may decrease.

In the optical glass according to the present embodiment, the mass ratio of the amount of BaO to the total amount of MgO, CaO, SrO, and BaO [BaO/(MgO+CaO+SrO+BaO)] is 0.7 or less. The upper limit of the mass ratio is preferably 0.65, and more preferably 0.60, 0.55, 0.50, 0.40, 0.30, and 0.25 in order. In addition, the lower limit of the mass ratio is preferably 0.01, and more preferably 0.05, 0.10, and 0.15 in order.

An optical glass in which the specific gravity is reduced and high dispersibility is maintained can be obtained by setting the mass ratio [BaO/(MgO+CaO+SrO+BaO)] in the above-described range. When the mass ratio is too large, the specific gravity of the glass may increase, the thermal stability may decrease, and the devitrification resistance may decrease.

In the optical glass according to the present embodiment, the total amount of TiO₂ and Nb₂O₅ [TiO₂+Nb₂O₅] is 30% or more. The lower limit of the total amount is preferably 30.0%, and more preferably 31.0%, 32.0%, 33.0%, 34.0%, and 35.0% in order. In addition, the upper limit of the total amount is preferably 60.0%, and more preferably 55.0%, 50.0%, and 45.0% in order.

Both TiO₂ and Nb₂O₅ are components contributing to increasing the refractive index. Therefore, an optical glass in which the refractive index is high and the specific gravity is reduced can be obtained by setting the total amount [TiO₂+Nb₂O₅] in the above-described range.

In the optical glass according to the present embodiment, the mass ratio of the amount of TiO₂ to the total amount of TiO₂, Nb₂O₅, Y₂O₃, ZrO₂, La₂O₃, Gd₂O₃, Ta₂O₅, WO₃, Yb₂O₃, and Bi₂O₃ [TiO₂/(TiO₂+Nb₂O₅+Y₂O₃+ZrO₂+La₂O₃+Gd₂O₃+Ta₂O₅+WO₃+Yb₂O₃+Bi₂O₃)] is 0.6 or more. The lower limit of the mass ratio is preferably 0.65, and more preferably 0.66, 0.67, and 0.68 in order. In addition, the upper limit of the mass ratio is preferably 0.95, and more preferably 0.90, 0.88, 0.86, 0.84, and 0.82 in order.

An optical glass in which the refractive index is high and the specific gravity is reduced can be obtained by setting the mass ratio [TiO₂/(TiO₂+Nb₂O₅+Y₂O₃+ZrO₂+La₂O₃+Gd₂O₃+Ta₂O₅+WO₃+Yb₂O₃+Bi₂₀₃)] in the above-described range.

Non-limiting examples of the amount and ratio of glass components other than those described above in the optical glass according to the present embodiment will be given below.

In the optical glass according to the present embodiment, the lower limit of the mass ratio of the amount of TiO₂ to the amount of Nb₂O₅ [TiO₂/Nb₂O₅] is preferably 1.5, and more preferably 1.6, 1.7, 1.8, 1.9, and 2.0 in order. In addition, the upper limit of the mass ratio is preferably 20.0, and more preferably 19.0, 18.0, 17.0, 16.0, and 15.0 in order.

From the viewpoint of obtaining an optical glass in which the refractive index is high, the specific gravity is reduced, and the raw material costs are reduced, it is preferable that the mass ratio [TiO₂/Nb₂O₅] is set in the above-described range. Meanwhile, when the mass ratio is too small, the liquidus temperature may increase and the meltability may deteriorate, so that the erosion of the refractory bricks during melting of the glass may increase. As a result, the manufacturing cost may increase. In addition, when the mass ratio is too large, the devitrification resistance of the glass may decrease and the transmittance of the glass may decrease.

In the optical glass according to the present embodiment, the upper limit of the mass ratio of the amount of Nb₂O₅ to the total amount of TiO₂, Nb₂O₅, Y₂O₃, ZrO₂, La₂O₃, Gd₂O₃, Ta₂O₅, WO₃, Yb₂O₃, and Bi₂O₃ [Nb₂O₅/(TiO₂+Nb₂O₅+Y₂O₃+ZrO₂+La₂O₃+Gd₂O₃+Ta₂O₅+WO₃+Yb₂O₃+Bi₂O₃)] is preferably 0.30, and more preferably 0.25 and 0.20 in order. In addition, the lower limit of the mass ratio is preferably 0.01, and more preferably 0.02, 0.03, 0.04, and 0.05 in order.

From the viewpoint of obtaining an optical glass in which the refractive index is high, the specific gravity is reduced, and the raw material costs are reduced, it is preferable that the mass ratio [Nb₂O₅/(TiO₂+Nb₂O₅+Y₂O₃+ZrO₂+La₂O₃+Gd₂O₃+Ta₂O₅+WO₃+Yb₂O₃+Bi₂O₃)] is set in the above-described range.

In the optical glass according to the present embodiment, the lower limit of the mass ratio of the total amount of TiO₂, Nb₂O₅, Y₂O₃, ZrO₂, La₂O₃, Gd₂O₃, Ta₂O₅, WO₃, Yb₂O₃, and Bi₂O₃ to the total amount of MgO, CaO, SrO, and BaO [(TiO₂+Nb₂O₅+Y₂O₃+ZrO₂+La₂O₃+Gd₂O₃+Ta₂O₅+WO₃+Yb₂O₃+Bi₂₀₃)/(MgO+CaO+SrO+BaO)] is preferably 1.0, and more preferably 1.1, 1.2, 1.3, and 1.4 in order. In addition, the upper limit of the mass ratio is preferably 3.0, and more preferably 2.9, 2.8, 2.7, and 2.6 in order.

From the viewpoint of obtaining an optical glass in which the refractive index is high, the specific gravity is reduced, and the raw material costs are reduced, it is preferable that the mass ratio [(TiO₂+Nb₂O₅+Y₂O₃+ZrO₂+La₂O₃+Gd₂O₃+Ta₂O₅+WO₃+Yb₂O₃+Bi₂₀₃)/(MgO+CaO+SrO+BaO)] is set in the above-described range.

Both As₂O₃ and PbO are toxic. Therefore, in the optical glass according to the present embodiment, the amount of each of As₂O₃ and PbO is preferably 0%, and it is preferable that As₂O₃ and PbO are substantially not contained.

In the optical glass according to the present embodiment, the upper limit of the amount of P₂O₅ is preferably 5.0%, and more preferably 4.0%, 3.0%, 2.0%, 1.0%, and 0.6% in order. In addition, it is preferable that the amount of P₂O₅ is low, and the lower limit of P₂O₅ is preferably 0.0%. The amount of P₂O₅ may be 0.0%.

From the viewpoint of suppressing devitrification of the glass and suppressing erosion of the refractory bricks during melting of the glass, it is preferable that the amount of P₂O₅ is set in the above-described range.

In the optical glass according to the present embodiment, the lower limit of the amount of Al₂O₃ is preferably 0.00%, and more preferably 0.01%, 0.02%, and 0.03% in order. The upper limit of the amount of Al₂O₃ is preferably 5.0%, and more preferably 4.0%, 3.0%, 2.0%, 1.0%, and 0.5% in order. The amount of Al₂O₃ may be 0.00%.

Al₂O₃ is a component having a small effect on reducing the specific gravity and a function of decreasing the refractive index. From the viewpoint of obtaining a glass having a high refractive index and a low specific gravity, it is preferable that the amount of Al₂O₃ is as low as possible. When the amount of Al₂O₃ is too high, the devitrification resistance of the glass may decrease, a glass transition temperature Tg may increase, and the thermal stability may decrease.

In the optical glass according to the present embodiment, the lower limit of the amount of ZrO₂ is preferably 0.01%, and more preferably 0.05%, 0.10%, 0.30%, and 0.50% in order. In addition, the upper limit of the amount of ZrO₂ is preferably 20.0%, more preferably 15.0%, 12.0%, and 10.0% in order.

When the amount of ZrO₂ is too low, the erosion of the refractory bricks may increase. When the amount of ZrO₂ is too high, the meltability of the glass may deteriorate. From the viewpoint of obtaining an optical glass having a high refractive index while suppressing erosion of the refractory bricks and from the viewpoint of maintaining the meltability and thermal stability of the glass, it is preferable that the amount of ZrO₂ is set in the above-described range.

In the optical glass according to the present embodiment, the upper limit of the amount of WO₃ is 10.0%, and more preferably 5.0%, 3.0%, 2.0%, 1.0%, and 0.5% in order. The lower limit of the amount of WO₃ is preferably 0.0%. The amount of WO₃ may be 0.0%.

From the viewpoint of obtaining an optical glass in which the specific gravity is reduced and the ultraviolet transmittance is reduced, it is preferable that the amount of WO₃ is set in the above-described range. Meanwhile, when the amount of WO₃ is too high, the internal transmittance may decrease and the specific gravity may increase. In addition, the transmittance in the visible range, particularly in the short wavelength range, may decrease, and the glass may become unstable.

In the optical glass according to the present embodiment, the upper limit of the amount of Bi₂O₃ is 5.0%, and more preferably 3.0%, 2.0%, 1.0%, and 0.5% in order. The lower limit of the amount of Bi₂O₃ is preferably 0.0%. The amount of Bi₂O₃ may be 0.0%.

From the viewpoint of obtaining an optical glass in which the specific gravity is reduced and the ultraviolet transmittance is reduced, it is preferable that the amount of Bi₂O₃ is set in the above-described range. Meanwhile, when the amount of Bi₂O₃ is too high, the specific gravity may increase, and the internal transmittance as well as the transmittance in the short wavelength range may decrease. In addition, the amount of erosion of platinum by the glass may increase and the coloration of the glass may increase.

In the optical glass according to the present embodiment, the upper limit of the amount of Li₂O is preferably 5.0%, and more preferably 4.0%, 3.0%, and 2.0% in order. It is preferable that the amount of Li₂O is low, and the lower limit of Li₂O is preferably 1.0%, and more preferably as low as 0.5%, 0.1%, and 0.0% in order. The amount of Li₂O may be 0.0%.

From the viewpoint of obtaining an optical glass in which the refractive index is high, the specific gravity is reduced, and the raw material costs are reduced, it is preferable that the amount of Li₂O is set in the above-described range. In addition, Li₂O has a function of improving the meltability of the glass and reducing the resistivity of the molten glass, and a function of suppressing reduction coloration that has the possibility of occurring during melting of the glass. Meanwhile, when the amount of Li₂O is too high, the chemical durability and the weather resistance may decrease, and the reheat stability may decrease.

In the optical glass according to the present embodiment, the upper limit of the amount of Na₂O is preferably 15.0%, and more preferably 12.0%, 10.0%, and 8.0% in order. The lower limit of the amount of Na₂O is preferably 0.50%, and more preferably 1.0%, 1.5%, and 2.0% in order.

From the viewpoint of obtaining an optical glass in which the specific gravity is reduced, it is preferable that the amount of Na₂O is set in the above-described range. In addition, Na₂O has a function of improving the meltability of the glass and reducing the resistivity of the molten glass. Meanwhile, when the amount of Na₂O is too low, the meltability of the glass may decrease. When the amount of Na₂O is too high, the refractive index may decrease.

In the optical glass according to the present embodiment, the upper limit of the amount of K₂O is preferably 10.0%, and more preferably 8.0%, 6.0%, 5.0%, and 4.0% in order. It is preferable that the amount of K₂O is low, and the lower limit of K₂O is preferably 1.0%, and more preferably as low as 0.50%, 0.30%, 0.10%, 0.05%, and 0.01% in order. The amount of K₂O may be 0.0%.

From the viewpoint of improving the meltability of the glass, it is preferable that the amount of K₂O is set in the above-described range. Meanwhile, when the amount of K₂O is too high, the refractive index may decrease significantly.

In the optical glass according to the present embodiment, the upper limit of the amount of Cs₂O is preferably 15.0%, and more preferably 10.0%, 5.0%, 4.0%, 3.0%, 2.0%, and 1.0% in order. The lower limit of the amount of Cs₂O is preferably 0.0%. The amount of Cs₂O may be 0.0%.

Cs₂O has a function of improving the meltability of the glass and improving the thermal stability. Meanwhile, when the amount of Cs₂O is too high, the refractive index may decrease significantly and the chemical durability of the glass may deteriorate.

In the optical glass according to the present embodiment, the upper limit of the amount of MgO is preferably 10.0%, and more preferably 8.0%, 6.0%, 4.0%, and 2.0% in order. In addition, it is preferable that the amount of MgO is low, and the lower limit of MgO is preferably 0.0%. The amount of MgO may be 0.0%.

From the viewpoint of improving the stability of the glass and reducing coloration of the glass, it is preferable that the amount of MgO is set in the above-described range. Meanwhile, when the amount of MgO is too high, both a high refractive index and a low specific gravity may not be achieved.

In the optical glass according to the present embodiment, the upper limit of the amount of CaO is preferably 20.0%, and more preferably 18.0%, 16.0%, 14.0%, 12.0%, and 10.0% in order. In addition, the lower limit of the amount of CaO is preferably 1.0%, and more preferably 2.0%, 3.0%, and 4.0% in order.

From the viewpoint of obtaining an optical glass in which the refractive index is high, the specific gravity is reduced, and the meltability is improved, it is preferable that the amount of CaO is set in the above-described range. Meanwhile, when the amount of CaO is too low, both a high refractive index and a low specific gravity may not be achieved. In addition, when the amount of CaO is too high, the thermal stability of the glass may decrease and the devitrification resistance may decrease.

In the optical glass according to the present embodiment, the upper limit of the amount of SrO is preferably 20.0%, and more preferably 19.0%, 18.0%, 17.0%, 16.0%, and 15.0% in order. In addition, the lower limit of the amount of SrO is preferably 1.0%, and more preferably 1.5%, 2.0%, and 2.3% in order.

From the viewpoint of improving the meltability, it is preferable that the amount of SrO is set in the above-described range. Meanwhile, when the amount of SrO is too high, the specific gravity may increase, high dispersibility may not be maintained, the thermal stability of the glass may decrease, and the devitrification resistance may decrease.

In the optical glass according to the present embodiment, the upper limit of the amount of BaO is preferably 25.0%, and more preferably 24.0%, 23.0%, 22.0%, 21.0%, and 20.0% in order. In addition, the lower limit of the amount of BaO is preferably 0.50%, and more preferably 0.70%, 1.0%, 1.20%, and 1.50% in order.

From the viewpoint of improving the meltability, it is preferable that the amount of BaO is set in the above-described range. Meanwhile, when the amount of BaO is too low, the stability of the glass may decrease. In addition, when the amount of BaO is too high, the specific gravity may increase significantly, high dispersibility may not be maintained, the thermal stability of the glass may decrease, and the devitrification resistance may decrease.

In the optical glass according to the present embodiment, the upper limit of the amount of ZnO is preferably 10.0%, and more preferably 8.0%, 6.0%, 4.0%, and 2.0% in order. In addition, it is preferable that the amount of ZnO is low, and the lower limit of ZnO is preferably 0.0%. The amount of ZnO may be 0.0%.

From the viewpoint of decreasing the glass transition temperature Tg, it is preferable that the amount of ZnO is set in the above-described range. Meanwhile, when the amount of ZnO is too high, in addition to an increase in specific gravity, the stability of the glass may be impaired.

In the optical glass according to the present embodiment, the upper limit of the amount of La₂O₃ is preferably 10.0%, and more preferably 5.0%, 4.0%, 3.0%, 2.0%, and 1.0% in order. In addition, the lower limit of the amount of La₂O₃ is preferably 0.0%. The amount of La₂O₃ may be 0.0%.

From the viewpoint of obtaining an optical glass having a high refractive index without deteriorating the internal transmittance of the glass, it is preferable that the amount of La₂O₃ is set in the above-described range. Meanwhile, when the amount of La₂O₃ is low, the refractive index tends to decrease. In addition, when the amount of La₂O₃ is too high, the specific gravity may increase and the thermal stability of the glass may decrease.

In the optical glass according to the present embodiment, the upper limit of the amount of Gd₂O₃ is preferably 10.0%, and more preferably 5.0%, 4.0%, 3.0%, 2.0%, and 1.0% in order. In addition, it is preferable that the amount of Gd₂O₃ is low, and the lower limit of Gd₂O₃ is preferably 0.0%. The amount of Gd₂O₃ may be 0.0%.

From the viewpoint of obtaining an optical glass having a high refractive index without deteriorating the internal transmittance of the glass, it is preferable that the amount of Gd₂O₃ is set in the above-described range. Meanwhile, when the amount of Gd₂O₃ is too high, the thermal stability of the glass may decrease and the specific gravity may increase. The manufacturing cost of the glass may increase.

In the optical glass according to the present embodiment, the upper limit of the amount of Y₂O₃ is preferably 10.0%, and more preferably 8.0%, 5.0%, 3.0%, 2.0%, and 1.5% in order. In addition, the lower limit of the amount of Y₂O₃ is preferably 0.0%.

An optical glass having a high refractive index and a small specific gravity without deteriorating the internal transmittance of the glass can be obtained by introducing Y₂O₃ in the above-described range, for example, instead of ZrO₂ or Nb₂O₅. Meanwhile, when the amount of Y₂O₃ is low, the refractive index tends to decrease. In addition, when the amount of Y₂O₃ is too high, the thermal stability of the glass may decrease and the devitrification resistance may decrease.

In the optical glass according to the present embodiment, the upper limit of the amount of GeO₂ is preferably 10.0%, and more preferably 6.0%, 4.0%, 3.0%, 2.0%, and 1.0% in order. In addition, it is preferable that the amount of GeO₂ is low, and the lower limit of GeO₂ is preferably 0.0%.

GeO₂ is an expensive glass component, and when the amount of GeO₂ is too high, the manufacturing cost may increase.

In the optical glass according to the present embodiment, the upper limit of the amount of Ta₂O₅ is preferably 5%, and more preferably 3%, 2%, and 1% in order. In addition, the lower limit of the amount of Ta₂O₅ is preferably 0%. The amount of Ta₂O₅ may be 0.0%.

Ta₂O₅ is a glass component having a function of increasing the refractive index without deteriorating the internal transmittance of the glass. Meanwhile, Ta₂O₅ is an expensive glass component, and when the amount of Ta₂O₅ is high, the raw material costs may increase. In addition, the specific gravity may increase. Therefore, it is preferable that the amount of Ta₂O₅ is set in the above-described range.

In the optical glass according to the present embodiment, the amount of Sc₂O₃ is preferably 2% or less. In addition, the lower limit of the amount of Sc₂O₃ is preferably 0%.

In the optical glass according to the present embodiment, the amount of HfO₂ is preferably 2% or less. In addition, the lower limit of the amount of HfO₂ is preferably 0%.

Sc₂O₃ and HfO₂ have a function of increasing the refractive index of the glass, but are expensive components. Therefore, it is preferable that the amount of each of Sc₂O₃ and HfO₂ is set in the above-described range.

In the optical glass according to the present embodiment, the amount of Lu₂O₃ is preferably 2% or less. In addition, the lower limit of the amount of Lu₂O₃ is preferably 0%.

Lu₂O₃ has a function of adjusting the refractive index of the glass but is a glass component that increases the specific gravity of the glass since Lu₂O₃ has a large molecular weight. Therefore, it is preferable that the amount of Lu₂O₃ is set in the above-described range.

In the optical glass according to the present embodiment, the amount of Yb₂O₃ is preferably 2% or less, more preferably 1% or less, and still more preferably 0.5% or less. In addition, the lower limit of the amount of Yb₂O₃ is preferably 0%. The amount of Yb₂O₃ may be 0.0%.

Since Yb₂O₃ has a function of adjusting the refractive index of the glass but has a large molecular weight, Yb₂O₃ increases the specific gravity of the glass. When the specific gravity of the glass increases, the mass of an optical element increases. Therefore, it is desirable that the amount of Yb₂O₃ is reduced to suppress an increase in the specific gravity of the glass.

In addition, when the amount of Yb₂O₃ is too high, the thermal stability of the glass may decrease. Furthermore, Yb₂O₃ brings about absorption in the infrared range. From the viewpoint of preventing a decrease in the thermal stability of the glass and suppressing an increase in specific gravity, it is preferable that the amount of Yb₂O₃ is set in the above-described range.

It is preferable that the optical glass according to the present embodiment is mainly composed of the above-described glass components, namely, SiO₂, TiO₂, and Nb₂O₅ as essential components, and B₂O₃, P₂O₅, Al₂O₃, ZrO₂, WO₃, Bi₂O₃, Li₂O, Na₂O, K₂O, Cs₂O, MgO, CaO, SrO, BaO, ZnO, La₂O₃, Gd₂O₃, Y₂O₃, GeO₂, Ta₂O₅, Sc₂O₃, HfO₂, Lu₂O₃, and Yb₂O₃ as optional components, and the total amount of the above-described glass components is preferably 95% or more, more preferably 98% or more, still more preferably 99% or more, and even more preferably 99.5% or more.

Incidentally, it is preferable that the optical glass according to the present embodiment is essentially composed of the above-described glass components, but can also contain other components to the extent that the actions and effects of the present invention are not impaired. In addition, in the present invention, the inclusion of inevitable impurities is not excluded.

### (Other Components)

Cd, Tl, Be, and Se are all toxic. Therefore, it is preferable that the optical glass according to the present embodiment does not contain these elements as glass components.

U, Th, and Ra are all radioactive elements. Therefore, it is preferable that the optical glass according to the present embodiment does not contain these elements as glass components.

V, Cr, Mn, Fe, Co, Ni, Cu, Pr, Nd, Pm, Sm, Eu, Tb, Dy, Ho, Er, and Tm increase the coloration of the glass, and can be sources of fluorescence. Therefore, the optical glass according to the present embodiment can contain trace amounts of these elements as glass components to the extent that the function of the optical glass is not impaired; however, it is preferable that the optical glass does not substantially contain these components.

Sb₂O₃ and CeO₂ are optionally addable elements that function as clarifying agents. Of these elements, Sb₂O₃ is a clarifying agent having a large clarifying effect. CeO₂ has a smaller clarifying effect than Sb₂O₃. CeO₂ tends to intensify the coloration of the glass when added in a large amount.

The amount of Sb₂O₃ is expressed as an exclusive percentage. Namely, when the total amount of all glass components other than Sb₂O₃ and CeO₂ is taken as 100% by mass, the amount of Sb₂O₃ is preferably 1.0% by mass or less, and more preferably 0.4% by mass or less, 0.2% by mass or less, 0.1% by mass or less, 0.05% by mass or less, 0.03% by mass or less, 0.02% by mass or less, and 0.01% by mass or less in order. The amount of Sb₂O₃ may be 0% by mass.

The amount of CeO₂ is also expressed as an exclusive percentage. Namely, when the total amount of all glass components other than CeO₂ and Sb₂O₃ is taken as 100% by mass, the amount of CeO₂ is preferably in a range of 2% by mass or less, more preferably 1% by mass or less, still more preferably 0.5% by mass or less, and even more preferably 0.1% by mass or less. The amount of CeO₂ may be 0% by mass. The clarity of the glass can be improved by setting the amount of CeO₂ in the above-described range.

### (Properties of Glass)

<Refractive Index nd>

In the optical glass according to the present embodiment, the upper limit of the refractive index nd can be set to 2.00, and can also be set to 1.99, 1.98, 1.97, 1.96, or 1.95. In addition, the lower limit of the refractive index nd can be set to 1.82, or can also be set to 1.83, 1.84, or 1.85. The refractive index can be controlled by adjusting the amount of glass components contributing to increasing the refractive index, such as TiO₂, Nb₂O₅, ZrO₂, and Y₂O₃, adjusting the amount of low refractive index components such as SiO₂, Al₂O₃, and B₂O₃, or introducing a modifying component such as CaO.

<Abbe Number vd>

In the optical glass according to the present embodiment, the upper limit of the Abbe number vd can be set to 30.0, and can also be set to 29.0, 28.0, 27.0, 26.0, 25.0, or 24.0. In addition, the lower limit of the Abbe number vd can be set to 15.0, and can also be set to 16.0, 17.0, 18.0, 19.0, 20.0, 21.0, or 22.0. A glass having a desired dispersibility can be obtained by setting the Abbe number vd in the above-described range. The Abbe number vd can be controlled by adjusting the amount of TiO₂, Nb₂O₅, WO₃, ZrO₂, and Bi₂O₃ that are glass components contributing to increasing dispersion.

### <Specific Gravity of Glass>

The optical glass according to the present embodiment is a high refractive index glass but does not have a large specific gravity. If the specific gravity of the glass can be reduced, the weight of a lens can be reduced. Meanwhile, when the specific gravity is too small, the thermal stability may decrease.

Therefore, in the optical glass according to the present embodiment, the upper limit of the specific gravity is preferably 7.0, and more preferably 6.0, 5.0, 4.5, and 4.0 in order. The lower limit of the specific gravity is preferably 2.5, and more preferably 2.8, 3.0 and 3.2 in order.

The specific gravity is determined by the atomic weight of the constituent components contained in the glass and the volume occupied by those atoms. For example, when an oxide containing a sixth period element or an element having a large atomic number of 57 or higher is introduced, the specific gravity tends to increase; however, when the volume occupied by the element is also large, the increase in specific gravity is suppressed. However, when the volume occupied by an element is too large, the refractive index decreases. In addition, the volume occupied by an element is not intrinsic, and varies to some extent depending on the presence of other glass components. In this way, the specific gravity value can be controlled by adjusting the total amount or ratio of each component. Furthermore, the volume occupied by each element varies to some extent depending on the slow cooling conditions of the glass.

### <Glass Transition Temperature Tg>

In the optical glass according to the present embodiment, the upper limit of the glass transition temperature Tg is not particularly limited: however, when productivity such as the time required for slow cooling is taken into consideration, the upper limit of the glass transition temperature Tg is preferably 850° C., and more preferably 800° C., 750° C., and 700° C. in order. In addition, the lower limit of the glass transition temperature Tg is not particularly limited; however, from the viewpoint of providing the optical glass with adequate heat resistance, the lower limit of the glass transition temperature Tg is preferably 100° C., and more preferably 200° C., 300° C., 400° C., and 500° C. in order. The glass transition temperature Tg is controlled by increasing or decreasing the amount of the network-forming components of the glass or adjusting the ratio or the like of each component.

By ensuring that the upper limit of the glass transition temperature Tg satisfies the above-described range, the increase in molding temperature and annealing temperature during reheat pressing of the glass can be suppressed, and thermal damage to a reheat press molding machine and an annealing machine can be reduced.

By ensuring that the lower limit of the glass transition temperature Tg satisfies the above-described range, it is made easier to maintain good reheat press moldability and good thermal stability of the glass while maintaining a desired Abbe number and a desired refractive index.

### <Coloration Degree of Glass>

In the optical glass according to the present embodiment, the light transmittance can be evaluated based on coloration degrees λ80, λ70, and λ5. The spectral transmittance of a glass sample with a thickness of 10.0 mm±0.1 mm is measured in a wavelength range of 200 to 700 nm, the wavelength at which the external transmittance is 80% is defined as λ80, the wavelength at which the external transmittance is 70% is defined as λ70, and the wavelength at which the external transmittance is 5% is defined as λ5. The upper limit of 280 of the optical glass according to the present embodiment is preferably 690 nm, and may be 685 nm or 680 nm. The upper limit of λ70 is preferably 680 nm, and may be 670 nm or 660 nm. The upper limit of 25 is preferably 400 nm, and may be 395 nm or 390 nm.

### (Manufacture of Optical Glass)

The optical glass according to the present embodiment may be produced by formulating glass raw materials so as to obtain the above-described predetermined composition, and using the formulated glass raw materials in accordance with a known glass manufacturing method. For example, an optical glass is obtained by formulating a plurality of types of compounds, thoroughly mixing the compounds to obtain batch raw materials, placing and heating the batch raw materials in a crucible made of refractory bricks to form molten glass, clarifying and homogenizing the molten glass, and then molding and slow cooling the molten glass. The clarification or homogenization step can also be carried out by performing melting in a platinum crucible as appropriate. When melting is performed in a platinum crucible, melting can also be performed in a non-oxidizing atmosphere, namely, a nitrogen atmosphere, a water vapor atmosphere, or the like in order to suppress oxidation of platinum. Known methods may be applied to the molding and slow cooling of the molten glass. Incidentally, cullet obtained by rapidly cooling molten glass that is roughly melted in refractory bricks or a quartz crucible may be used as the glass raw materials.

Incidentally, as long as desired glass components can be introduced into the glass in desired amounts, compounds that are used when the batch raw materials are formulated is not particularly limited: however, examples of such compounds include oxides, carbonates, nitrates, hydroxides, hydrates, fluorides, chlorides, and the like.

### (Manufacture of Optical Element or the Like)

A known method may be applied to the manufacture of an optical element using the optical glass according to the embodiment of the present invention. For example, in the manufacture of the above-described optical glass, molten glass is cast into a mold and is molded into a plate shape to produce a glass material made of the optical glass according to the present invention. The obtained glass material is appropriately cut, ground, and polished to produce cut pieces of a size and shape suitable for press molding. The cut pieces are heated, softened, and press-molded (reheat-pressed) using a known method to produce an optical element blank that approximates the shape of the optical element. The optical element blank is annealed, ground, and polished using known methods to produce an optical element.

An optical functional surface of the produced optical element may be coated with an anti-reflection film, a total reflection film, or the like depending on the intended use.

According to one aspect of the present invention, the optical element made of the above-described optical glass can be provided. Examples of types of the optical element include lenses such as flat lenses, spherical lenses, and aspherical lenses, prisms, diffraction gratings, and light guide plates. Examples of lens shapes include the shapes of a biconvex lens, a plano-convex lens, a biconcave lens, a plano-concave lens, a convex meniscus lens, a concave meniscus lens, and the like.

The optical element can be manufactured by a method including a step of processing a glass molded body made of the above-described optical glass. Examples of the processing include cutting, machining, rough grinding, fine grinding, polishing, and the like. By using the above-described glass, breakage can be reduced and high-quality optical elements can be stably supplied.

The light guide plate can be produced by a known method using the above-described optical glass. Examples of applications of the light guide plate include display devices such as eyeglass-type devices including an augmented reality (AR) display type, a mixed reality (MR) display type, and a virtual reality (VR) display type. Such a light guide plate is a plate-shaped glass that is attached to the frame of an eyeglass-type device, and is made of the above-described optical glass. If necessary, a diffraction grating for changing a traveling direction of light propagating through the inside of the light guide plate by repeating total reflection may be formed on a surface of the light guide plate. The diffraction grating can be formed by a known method. When a user wears an eyeglass-type device including the above-described light guide plate, light propagating through the inside of the light guide plate is incident on the pupils, so that the function of an augmented reality (AR) display, a mixed reality (MR) display, or a virtual reality (VR) display is realized. Such an eyeglass-type device is disclosed, for example, in JP 2017-534352 A and the like.

An optical element, particularly a lens or a light guide plate can be made less susceptible to breakage by chemically strengthening the glass during the manufacturing process. A known method may be applied to the chemical strengthening.

### EXAMPLES

Hereinafter, the present invention will be described in more detail with reference to Examples. However, the present invention is not limited to aspects shown in Examples.

### Example 1

Glass samples having glass compositions shown in Tables 1 (1) to 1 (4), Tables 2 (1) to 2 (4), and Tables 3 (1) to 3 (4) were produced by the following procedure, and various evaluations were performed. Incidentally, No. 64 is a comparative example.

### [Production of Optical Glass]

An oxide, a hydroxide, a carbonate, and a nitrate corresponding to the constituent components of the glass were prepared as raw materials, and the raw materials were weighed, formulated, and thoroughly mixed such that the glass composition of the obtained optical glass became each composition shown in Tables 1(1) to 1(4). The formulated raw materials (batch raw materials) thus obtained were placed in a crucible made of a refractory oxide and were heated at 1150° C. to 1450° C. for 1 hour to form molten glass, and the molten glass was transferred to a platinum crucible, was stirred to homogenize the molten glass, was clarified, and then was cast into a mold preheated to an appropriate temperature. Alternatively, the raw materials formulated in advance were placed in a platinum crucible, were heated for 2 hours, and then were cast into a mold using the same procedure. Glass samples were obtained by heat-treating the cast glass for 30 minutes at a temperature near the glass transition temperature Tg or approximately 10 to 100° C. lower than Tg, and allowing the cast glass to cool to room temperature in a furnace.

### [Confirmation of Glass Component Composition]

The amount of each glass component in the obtained glass samples were measured by inductively coupled plasma atomic emission spectroscopy (ICP-AES), and it was confirmed that each composition was as shown in Table 1 (1) to 1 (4).

### [Measurement of Optical Properties]

Annealed samples were obtained by further annealing the obtained glass samples at a temperature near the glass transition temperature Tg for about 30 minutes to about 2 hours, and then cooling the glass samples to room temperature in the furnace at a cooling rate of −30° C./hour. The refractive indices nd, ng, n_{F}, and n_{C}, the Abbe number vd, the specific gravity, the glass transition temperature Tg, and the coloration degrees λ80, λ70, and λ5 of the obtained annealed samples were measured. The results are shown in Tables 4 (1) to 1 (4).

(i) Refractive Index nd, ng, n_{F}, n_{C}, and Abbe Number vd

The refractive indices nd, ng, n_{F}, and n_{C} of the annealed samples were measured by the refractive index measurement method of JIS standard JIS B7071-1, and the Abbe number vd was calculated based on the following equation.

$$vd = ( nd - 1 ) / ( {n}_{F} - {n}_{C} )$$

### (ii) Specific Gravity

The specific gravity was measured by the Archimedes method.

(iii) Glass Transition Temperature Tg

The glass transition temperature Tg was measured using a differential scanning calorimeter (DSC 3300SA), which is manufactured by NETZSCH JAPAN Co., Ltd., at a heating rate of 10° C./min.

### (iv) Coloration Degree λ80, λ70, and λ5

The samples were processed to have a thickness of 10 mm and flat surfaces parallel to each other and optically polished, and the spectral transmittance was measured in a wavelength range from 280 nm to 700 nm. The intensity of light perpendicularly incident on one flat surface that is optically polished was defined as an intensity A, the intensity of light emitted from the other flat surface was defined as an intensity B, and a spectral transmittance B/A was calculated. The wavelength at which the spectral transmittance was 80% was defined as λ80, the wavelength at which the spectral transmittance was 70% was defined as λ70, and the wavelength at which the spectral transmittance was 5% was defined as λ5. Incidentally, the spectral transmittance also includes the reflection loss of light on the sample surface.

TABLE 1

| | Glass composition (% by mass) | | | | | | | | | | | | |
|---|---|---|---|---|---|---|---|---|---|---|---|---|---|
| No. | Al₂O₃ | SiO₂ | B₂O₃ | Li₂O | Na₂O | K₂O | MgO | CaO | SrO | Bao | ZrO₂ | Nb₂O₅ | TiO₂ |
| 1 | 0.00 | 20.20 | 3.14 | 0.00 | 4.01 | 0.00 | 0.00 | 8.85 | 2.49 | 18.41 | 1.69 | 7.72 | 33.50 |
| 2 | 0.00 | 21.17 | 3.29 | 0.00 | 4.20 | 0.00 | 1.71 | 9.27 | 2.61 | 12.79 | 1.77 | 8.09 | 35.10 |
| 3 | 0.00 | 21.02 | 3.27 | 0.00 | 4.17 | 0.00 | 0.00 | 11.57 | 2.59 | 12.70 | 1.76 | 8.04 | 34.87 |
| 4 | 0.00 | 21.92 | 3.40 | 0.00 | 4.35 | 0.00 | 0.00 | 14.53 | 2.70 | 6.51 | 1.84 | 8.38 | 36.36 |
| 5 | 0.00 | 20.61 | 3.20 | 0.00 | 4.09 | 0.00 | 0.00 | 9.03 | 6.82 | 12.45 | 1.73 | 7.88 | 34.18 |
| 6 | 0.00 | 21.04 | 3.27 | 0.00 | 4.18 | 0.00 | 0.00 | 9.22 | 11.33 | 6.25 | 1.76 | 8.05 | 34.90 |
| 7 | 0.00 | 20.80 | 3.23 | 0.00 | 4.13 | 0.00 | 0.00 | 9.11 | 2.56 | 12.57 | 1.74 | 7.96 | 34.50 |
| 8 | 0.00 | 20.21 | 3.14 | 0.00 | 4.01 | 0.00 | 0.00 | 8.85 | 2.49 | 18.42 | 2.52 | 6.83 | 33.52 |
| 9 | 0.00 | 20.22 | 3.14 | 0.00 | 4.02 | 0.00 | 0.00 | 8.86 | 2.49 | 18.43 | 3.36 | 5.94 | 33.54 |
| 10 | 0.00 | 20.75 | 3.22 | 0.00 | 4.12 | 0.00 | 0.00 | 9.09 | 8.30 | 10.41 | 1.74 | 7.94 | 34.42 |
| 11 | 0.00 | 20.90 | 3.25 | 0.00 | 4.15 | 0.00 | 0.00 | 9.15 | 9.80 | 8.35 | 1.75 | 7.99 | 34.66 |
| 12 | 0.00 | 20.86 | 4.21 | 0.00 | 4.14 | 0.00 | 0.00 | 9.14 | 2.57 | 14.74 | 1.75 | 7.98 | 34.60 |
| 13 | 0.00 | 21.11 | 3.28 | 0.00 | 4.19 | 0.00 | 0.00 | 9.25 | 9.91 | 6.27 | 1.77 | 8.07 | 36.14 |
| 14 | 0.00 | 21.33 | 3.31 | 0.00 | 4.24 | 0.00 | 0.00 | 9.35 | 10.01 | 4.15 | 1.79 | 8.16 | 37.66 |
| 15 | 0.00 | 21.26 | 3.30 | 0.00 | 4.66 | 0.00 | 0.00 | 9.31 | 9.97 | 6.32 | 1.78 | 8.13 | 35.26 |
| 16 | 0.00 | 21.64 | 3.36 | 0.00 | 5.19 | 0.00 | 0.00 | 9.48 | 10.15 | 4.21 | 1.81 | 8.27 | 35.88 |
| 17 | 0.00 | 21.19 | 3.29 | 0.00 | 4.21 | 0.00 | 0.00 | 10.07 | 9.94 | 6.29 | 1.77 | 8.10 | 35.14 |
| 18 | 0.00 | 21.48 | 3.34 | 0.00 | 4.27 | 0.00 | 0.00 | 11.02 | 10.08 | 4.18 | 1.80 | 8.22 | 35.63 |
| 19 | 0.00 | 21.42 | 3.33 | 0.00 | 4.70 | 0.00 | 0.00 | 9.38 | 10.05 | 6.36 | 1.79 | 6.29 | 36.67 |
| 20 | 0.00 | 20.33 | 3.16 | 0.00 | 4.04 | 0.00 | 1.64 | 6.62 | 2.50 | 18.53 | 1.70 | 7.77 | 33.71 |
| 21 | 0.00 | 20.40 | 3.17 | 0.00 | 5.32 | 0.00 | 0.00 | 6.65 | 2.51 | 18.60 | 1.71 | 7.80 | 33.84 |
| 22 | 0.00 | 21.29 | 3.31 | 0.00 | 4.67 | 0.00 | 0.00 | 9.33 | 9.99 | 6.32 | 3.53 | 6.25 | 35.31 |
| 23 | 0.00 | 21.32 | 3.31 | 0.00 | 4.67 | 0.00 | 0.00 | 9.34 | 10.00 | 6.33 | 5.29 | 4.37 | 35.36 |
| 24 | 0.00 | 21.35 | 3.32 | 0.00 | 4.68 | 0.00 | 0.00 | 9.35 | 10.02 | 6.34 | 7.06 | 2.48 | 35.41 |
| 25 | 0.00 | 21.32 | 3.31 | 0.00 | 4.67 | 0.00 | 0.00 | 9.34 | 10.00 | 6.33 | 1.78 | 6.26 | 35.36 |
| 26 | 0.00 | 21.38 | 3.32 | 0.00 | 4.69 | 0.00 | 0.00 | 9.37 | 10.03 | 6.35 | 1.79 | 4.38 | 35.46 |
| 27 | 0.00 | 21.44 | 3.33 | 0.00 | 4.70 | 0.00 | 0.00 | 9.39 | 10.06 | 6.37 | 1.79 | 2.49 | 35.56 |
| 28 | 0.00 | 21.31 | 3.31 | 0.00 | 4.67 | 1.34 | 0.00 | 7.74 | 10.00 | 6.33 | 1.78 | 8.15 | 35.35 |
| 29 | 0.00 | 21.37 | 3.32 | 0.00 | 4.69 | 2.69 | 0.00 | 6.16 | 10.03 | 6.35 | 1.79 | 8.17 | 35.44 |
| 30 | 0.00 | 21.61 | 3.36 | 0.00 | 4.74 | 1.36 | 0.00 | 9.47 | 7.15 | 6.42 | 1.81 | 8.26 | 35.84 |
| 31 | 0.00 | 21.97 | 3.41 | 0.00 | 4.82 | 2.76 | 0.00 | 9.62 | 4.23 | 6.53 | 1.84 | 8.40 | 36.43 |
| 32 | 0.00 | 21.07 | 3.27 | 0.00 | 2.88 | 2.65 | 0.00 | 9.23 | 9.88 | 6.26 | 1.76 | 8.06 | 34.94 |
| 33 | 0.00 | 21.41 | 3.33 | 0.00 | 5.58 | 0.00 | 0.00 | 7.78 | 10.05 | 6.36 | 1.79 | 8.19 | 35.51 |
| 34 | 0.00 | 21.57 | 3.35 | 0.00 | 6.51 | 0.00 | 0.00 | 6.22 | 10.12 | 6.41 | 1.81 | 8.25 | 35.77 |
| 35 | 0.00 | 21.71 | 3.37 | 0.00 | 5.66 | 0.00 | 0.00 | 9.51 | 7.18 | 6.45 | 1.82 | 8.30 | 36.00 |
| 36 | 0.00 | 22.18 | 3.44 | 0.00 | 6.70 | 0.00 | 0.00 | 9.71 | 4.27 | 6.59 | 1.86 | 8.48 | 36.78 |
| 37 | 0.00 | 21.29 | 3.31 | 0.00 | 4.67 | 1.34 | 0.00 | 7.73 | 9.99 | 4.14 | 1.78 | 8.14 | 35.30 |
| 38 | 0.00 | 21.26 | 3.30 | 0.00 | 4.66 | 1.34 | 0.00 | 7.72 | 9.97 | 1.96 | 1.78 | 8.13 | 35.26 |
| 39 | 0.00 | 21.38 | 3.32 | 0.00 | 4.69 | 1.34 | 0.00 | 7.77 | 8.55 | 6.35 | 1.79 | 8.18 | 35.46 |
| 40 | 0.00 | 21.45 | 3.33 | 0.00 | 4.70 | 1.35 | 0.00 | 7.79 | 7.10 | 6.37 | 1.80 | 8.20 | 35.58 |
| 41 | 0.00 | 21.26 | 3.30 | 0.00 | 4.66 | 1.34 | 0.00 | 7.72 | 7.03 | 6.32 | 1.78 | 8.13 | 35.26 |
| 42 | 0.00 | 21.54 | 3.34 | 0.00 | 4.72 | 1.35 | 0.00 | 7.82 | 10.10 | 4.19 | 1.80 | 8.24 | 35.72 |
| 43 | 0.00 | 21.76 | 3.38 | 0.00 | 4.77 | 1.37 | 0.00 | 7.90 | 10.21 | 2.01 | 1.82 | 8.32 | 36.09 |
| 44 | 0.00 | 21.44 | 3.33 | 0.00 | 4.70 | 1.35 | 0.00 | 7.79 | 10.06 | 4.17 | 1.79 | 8.20 | 35.56 |
| 45 | 0.00 | 21.56 | 3.35 | 0.00 | 4.73 | 1.36 | 0.00 | 7.83 | 10.12 | 1.99 | 1.80 | 8.25 | 35.76 |
| 46 | 0.00 | 21.39 | 3.32 | 0.00 | 4.69 | 1.35 | 0.00 | 7.77 | 8.55 | 6.35 | 1.79 | 8.18 | 36.61 |
| 47 | 0.00 | 21.24 | 3.30 | 0.00 | 4.66 | 1.34 | 0.00 | 6.92 | 9.97 | 6.31 | 1.78 | 8.12 | 36.36 |
| 48 | 0.00 | 21.36 | 3.32 | 0.00 | 4.68 | 1.34 | 0.00 | 7.76 | 10.02 | 5.25 | 2.67 | 8.17 | 35.43 |
| 49 | 0.00 | 21.41 | 3.32 | 0.00 | 4.69 | 1.35 | 0.00 | 7.77 | 10.04 | 4.17 | 3.55 | 8.19 | 35.50 |
| 50 | 0.00 | 21.29 | 3.31 | 0.00 | 4.67 | 1.34 | 0.00 | 7.73 | 9.25 | 6.32 | 2.66 | 8.14 | 35.30 |
| 51 | 0.00 | 21.26 | 3.30 | 0.00 | 4.66 | 1.34 | 0.00 | 7.72 | 8.50 | 6.31 | 3.53 | 8.13 | 35.25 |
| 52 | 0.00 | 18.16 | 5.37 | 0.00 | 4.74 | 1.36 | 0.00 | 7.85 | 10.15 | 6.42 | 1.81 | 8.27 | 35.87 |
| 53 | 0.00 | 19.75 | 4.33 | 0.00 | 4.71 | 1.35 | 0.00 | 7.80 | 10.07 | 6.38 | 1.80 | 8.21 | 35.61 |
| 54 | 0.00 | 22.86 | 2.30 | 0.00 | 4.64 | 1.33 | 0.00 | 7.69 | 9.93 | 6.29 | 1.77 | 8.09 | 35.10 |
| 55 | 0.00 | 24.38 | 1.31 | 0.00 | 4.61 | 1.32 | 0.00 | 7.63 | 9.86 | 6.24 | 1.76 | 8.04 | 34.85 |
| 56 | 0.00 | 21.38 | 3.32 | 0.00 | 4.69 | 1.34 | 0.00 | 7.77 | 10.03 | 6.35 | 0.91 | 8.18 | 36.03 |
| 57 | 0.00 | 21.45 | 3.33 | 0.00 | 4.70 | 1.35 | 0.00 | 7.79 | 10.06 | 6.37 | 0.00 | 8.20 | 36.74 |
| 58 | 0.00 | 21.30 | 3.31 | 0.00 | 4.67 | 1.34 | 0.00 | 7.74 | 9.99 | 6.33 | 0.91 | 9.09 | 35.33 |
| 59 | 0.00 | 21.29 | 3.31 | 0.00 | 4.67 | 1.34 | 0.00 | 7.73 | 9.99 | 6.32 | 0.00 | 10.06 | 35.30 |
| 60 | 0.00 | 21.39 | 4.32 | 0.00 | 4.69 | 0.00 | 0.00 | 7.77 | 10.04 | 6.35 | 1.79 | 8.18 | 35.48 |
| 61 | 0.00 | 20.92 | 3.56 | 0.00 | 4.68 | 1.34 | 0.00 | 7.76 | 10.02 | 6.34 | 1.79 | 8.17 | 35.41 |
| 62 | 0.00 | 20.53 | 3.82 | 0.00 | 4.69 | 1.35 | 0.00 | 7.77 | 10.04 | 6.35 | 1.79 | 8.18 | 35.48 |
| 63 | 0.00 | 18.95 | 4.85 | 0.00 | 4.72 | 1.36 | 0.00 | 7.83 | 10.11 | 6.40 | 1.80 | 8.24 | 35.74 |
| 64 | 0.00 | 19.49 | 0.92 | 1.68 | 2.26 | 0.00 | 0.00 | 8.54 | 2.40 | 17.77 | 1.63 | 21.30 | 24.01 |
| 65 | 0.00 | 21.28 | 3.30 | 0.00 | 4.66 | 0.00 | 0.00 | 9.32 | 10.35 | 6.32 | 1.34 | 8.14 | 35.29 |
| 66 | 0.00 | 21.29 | 3.31 | 0.00 | 4.67 | 0.00 | 0.00 | 9.33 | 10.73 | 6.32 | 0.91 | 8.14 | 35.31 |
| 67 | 0.00 | 21.31 | 3.31 | 0.00 | 4.67 | 0.00 | 0.00 | 9.33 | 11.10 | 6.33 | 0.47 | 8.15 | 35.33 |
| 68 | 0.00 | 21.32 | 3.31 | 0.00 | 4.67 | 0.00 | 0.00 | 9.34 | 11.50 | 6.33 | 0.00 | 8.15 | 35.36 |
| 69 | 0.00 | 20.47 | 3.31 | 0.00 | 4.67 | 0.00 | 0.57 | 9.34 | 10.00 | 6.33 | 1.78 | 8.15 | 35.36 |
| 70 | 0.00 | 19.66 | 3.32 | 0.00 | 4.69 | 0.00 | 1.15 | 9.37 | 10.03 | 6.35 | 1.79 | 8.18 | 35.46 |
| 71 | 0.00 | 20.42 | 3.30 | 0.00 | 4.66 | 0.00 | 0.00 | 10.12 | 9.98 | 6.32 | 1.78 | 8.14 | 35.28 |
| 72 | 0.00 | 19.58 | 3.31 | 0.00 | 4.67 | 0.00 | 0.00 | 10.92 | 9.99 | 6.32 | 1.78 | 8.14 | 35.30 |
| 73 | 0.00 | 21.33 | 3.31 | 0.00 | 4.68 | 0.00 | 0.00 | 9.34 | 10.01 | 6.34 | 3.54 | 5.79 | 35.66 |
| 74 | 0.00 | 21.37 | 3.32 | 0.00 | 4.69 | 0.00 | 0.00 | 9.36 | 10.03 | 6.35 | 3.55 | 5.33 | 36.01 |
| 75 | 0.00 | 21.41 | 3.33 | 0.00 | 4.69 | 0.00 | 0.00 | 9.38 | 10.05 | 6.36 | 3.55 | 4.86 | 36.37 |
| 76 | 0.00 | 21.45 | 3.33 | 0.00 | 4.70 | 0.00 | 0.00 | 9.40 | 10.06 | 6.37 | 3.56 | 4.40 | 36.72 |
| 77 | 0.00 | 19.73 | 4.33 | 0.00 | 4.70 | 1.01 | 0.00 | 8.19 | 10.07 | 6.37 | 1.80 | 8.21 | 35.58 |
| 78 | 0.00 | 19.72 | 4.33 | 0.00 | 4.70 | 0.67 | 0.00 | 8.59 | 10.06 | 6.37 | 1.79 | 8.20 | 35.56 |
| 79 | 0.00 | 19.71 | 4.32 | 0.00 | 4.70 | 0.34 | 0.00 | 8.99 | 10.05 | 6.37 | 1.79 | 8.20 | 35.54 |
| 80 | 0.00 | 19.70 | 4.32 | 0.00 | 4.70 | 0.00 | 0.00 | 9.38 | 10.05 | 6.36 | 1.79 | 8.19 | 35.52 |
| 81 | 0.00 | 20.61 | 3.83 | 0.00 | 4.71 | 1.35 | 0.00 | 7.80 | 10.07 | 6.38 | 1.80 | 7.26 | 36.19 |
| 82 | 0.00 | 20.69 | 3.85 | 0.00 | 4.73 | 1.36 | 0.00 | 7.83 | 10.11 | 6.40 | 1.80 | 6.33 | 36.90 |
| 83 | 0.00 | 20.58 | 3.83 | 0.21 | 4.26 | 1.35 | 0.00 | 7.79 | 10.06 | 6.37 | 1.79 | 8.20 | 35.56 |
| 84 | 0.00 | 20.63 | 3.84 | 0.43 | 3.82 | 1.35 | 0.00 | 7.81 | 10.08 | 6.38 | 1.80 | 8.22 | 35.64 |
| 85 | 0.00 | 20.68 | 3.85 | 0.64 | 3.39 | 1.35 | 0.00 | 7.82 | 10.11 | 6.40 | 1.80 | 8.24 | 35.72 |
| 86 | 0.00 | 20.72 | 3.86 | 0.86 | 2.95 | 1.36 | 0.00 | 7.84 | 10.13 | 6.41 | 1.81 | 8.26 | 35.81 |
| 87 | 0.00 | 20.39 | 3.79 | 0.00 | 4.66 | 1.34 | 0.00 | 7.71 | 8.50 | 8.48 | 1.78 | 8.12 | 35.23 |
| 88 | 0.00 | 20.25 | 3.77 | 0.00 | 4.62 | 1.33 | 0.00 | 7.66 | 6.98 | 10.58 | 1.77 | 8.07 | 34.98 |
| 89 | 0.00 | 20.11 | 3.74 | 0.00 | 4.59 | 1.32 | 0.00 | 7.61 | 5.48 | 12.66 | 1.75 | 8.01 | 34.74 |
| 90 | 0.00 | 20.25 | 3.77 | 0.00 | 4.63 | 1.33 | 0.00 | 6.87 | 9.90 | 8.43 | 1.77 | 8.07 | 34.99 |
| 91 | 0.00 | 19.71 | 3.67 | 0.00 | 4.50 | 1.29 | 0.00 | 5.15 | 9.63 | 12.41 | 1.72 | 7.85 | 34.06 |
| 92 | 0.00 | 20.40 | 3.79 | 0.00 | 4.66 | 1.34 | 0.00 | 6.92 | 11.44 | 6.31 | 1.78 | 8.13 | 35.24 |
| 93 | 0.00 | 20.26 | 3.77 | 0.00 | 4.63 | 1.33 | 0.00 | 6.08 | 12.82 | 6.27 | 1.77 | 8.07 | 35.00 |
| 94 | 0.00 | 20.32 | 3.78 | 0.00 | 4.20 | 1.33 | 0.00 | 7.69 | 11.40 | 6.29 | 1.77 | 8.10 | 35.11 |
| 95 | 0.00 | 20.12 | 3.74 | 0.00 | 3.73 | 1.32 | 0.00 | 7.61 | 12.73 | 6.23 | 1.75 | 8.01 | 34.76 |
| 96 | 0.00 | 20.35 | 3.79 | 0.00 | 4.65 | 1.33 | 0.00 | 7.70 | 8.48 | 6.30 | 5.26 | 8.11 | 34.03 |
| 97 | 0.00 | 20.17 | 3.75 | 0.00 | 4.61 | 1.32 | 0.00 | 7.63 | 6.95 | 6.24 | 8.68 | 8.04 | 32.61 |
| 98 | 0.00 | 20.21 | 3.76 | 0.00 | 4.62 | 1.32 | 0.00 | 6.86 | 9.88 | 6.26 | 5.23 | 8.05 | 33.80 |
| 99 | 0.00 | 18.86 | 3.83 | 0.43 | 4.70 | 1.35 | 0.00 | 7.79 | 10.06 | 8.57 | 1.79 | 8.20 | 34.42 |
| 100 | 0.00 | 20.51 | 3.81 | 0.43 | 4.68 | 0.00 | 0.00 | 7.76 | 10.02 | 8.53 | 1.79 | 8.17 | 34.29 |
| 101 | 0.00 | 20.51 | 3.81 | 0.85 | 2.92 | 1.34 | 0.00 | 7.76 | 10.02 | 8.53 | 1.79 | 8.17 | 34.29 |
| 102 | 0.00 | 17.96 | 5.31 | 0.00 | 4.69 | 1.35 | 0.00 | 7.77 | 10.04 | 8.55 | 1.79 | 8.18 | 34.35 |
| 103 | 0.00 | 20.39 | 4.78 | 0.00 | 4.66 | 0.00 | 0.00 | 7.72 | 9.97 | 8.49 | 1.78 | 8.12 | 34.10 |
| 104 | 0.00 | 20.34 | 3.78 | 0.00 | 5.08 | 0.00 | 0.00 | 8.49 | 9.94 | 8.46 | 1.77 | 8.10 | 34.02 |
| 105 | 0.00 | 20.27 | 3.77 | 0.00 | 4.63 | 0.00 | 0.00 | 9.25 | 9.91 | 8.43 | 1.77 | 8.08 | 33.90 |
| 106 | 0.00 | 18.64 | 3.78 | 0.00 | 4.65 | 1.33 | 0.00 | 9.28 | 9.94 | 8.47 | 1.77 | 8.11 | 34.02 |
| 107 | 0.00 | 20.58 | 3.83 | 0.43 | 4.70 | 0.00 | 0.00 | 7.79 | 10.06 | 9.44 | 1.79 | 6.30 | 35.10 |
| 108 | 0.00 | 21.17 | 3.94 | 0.79 | 4.84 | 0.00 | 0.00 | 8.01 | 10.35 | 6.55 | 1.85 | 6.87 | 35.64 |
| 109 | 0.00 | 20.63 | 3.84 | 0.86 | 3.82 | 0.00 | 0.00 | 7.81 | 10.09 | 10.79 | 1.80 | 5.17 | 35.20 |
| 110 | 0.00 | 20.57 | 3.83 | 0.86 | 3.81 | 0.00 | 0.00 | 7.78 | 10.06 | 10.76 | 1.79 | 5.91 | 34.63 |
| 111 | 0.00 | 20.69 | 3.85 | 1.29 | 2.94 | 0.00 | 0.00 | 7.83 | 10.11 | 12.14 | 1.80 | 4.04 | 35.30 |
| 112 | 0.00 | 20.61 | 3.83 | 0.86 | 3.37 | 0.00 | 0.58 | 7.80 | 10.07 | 10.77 | 1.80 | 5.16 | 35.15 |
| 113 | 0.37 | 20.64 | 3.84 | 0.86 | 3.83 | 0.00 | 0.00 | 7.41 | 10.09 | 10.79 | 1.80 | 5.17 | 35.21 |
| 114 | 0.00 | 20.29 | 3.77 | 0.42 | 4.63 | 0.00 | 0.00 | 7.68 | 6.99 | 13.64 | 1.77 | 6.21 | 34.60 |
| 115 | 0.00 | 20.36 | 3.79 | 0.42 | 4.65 | 0.00 | 0.00 | 7.71 | 7.02 | 13.69 | 1.78 | 5.29 | 35.30 |
| 116 | 0.00 | 20.44 | 3.80 | 0.42 | 4.67 | 0.00 | 0.00 | 7.73 | 7.04 | 13.74 | 1.78 | 4.36 | 36.00 |
| 117 | 0.00 | 20.52 | 3.82 | 0.43 | 4.69 | 0.00 | 0.00 | 7.76 | 7.07 | 13.79 | 1.79 | 3.43 | 36.71 |
| 118 | 0.00 | 20.56 | 3.83 | 0.43 | 4.48 | 0.00 | 0.29 | 7.78 | 10.05 | 9.43 | 1.79 | 6.29 | 35.07 |
| 119 | 0.00 | 20.55 | 3.82 | 0.43 | 4.25 | 0.00 | 0.58 | 7.78 | 10.04 | 9.43 | 1.79 | 6.29 | 35.05 |
| 120 | 0.00 | 20.54 | 3.82 | 0.43 | 4.03 | 0.00 | 0.86 | 7.77 | 10.04 | 9.42 | 1.79 | 6.28 | 35.03 |
| 121 | 0.00 | 20.52 | 3.82 | 0.43 | 3.80 | 0.00 | 1.15 | 7.76 | 10.03 | 9.42 | 1.79 | 6.28 | 35.00 |
| 122 | 0.00 | 20.26 | 3.77 | 0.42 | 4.19 | 0.00 | 0.57 | 7.67 | 6.98 | 13.62 | 1.77 | 6.20 | 34.56 |
| 123 | 0.00 | 20.19 | 3.76 | 0.42 | 4.18 | 0.00 | 0.57 | 7.64 | 6.23 | 14.65 | 1.76 | 6.18 | 34.44 |
| 124 | 0.00 | 20.12 | 3.74 | 0.42 | 4.16 | 0.00 | 0.56 | 7.61 | 5.48 | 15.67 | 1.75 | 6.16 | 34.32 |
| 125 | 0.00 | 20.27 | 3.77 | 0.42 | 4.19 | 0.00 | 0.57 | 7.67 | 6.25 | 14.70 | 1.77 | 5.26 | 35.13 |
| 126 | 0.00 | 20.34 | 3.78 | 0.42 | 4.21 | 0.00 | 0.57 | 7.70 | 6.28 | 14.76 | 1.77 | 4.34 | 35.83 |
| 127 | 0.00 | 20.04 | 3.73 | 0.00 | 4.58 | 1.31 | 0.00 | 7.58 | 4.02 | 14.75 | 1.75 | 7.06 | 35.18 |
| 128 | 0.00 | 20.35 | 3.79 | 0.42 | 4.43 | 0.00 | 0.29 | 7.70 | 6.65 | 14.22 | 1.77 | 4.82 | 35.56 |
| 129 | 0.00 | 20.28 | 3.77 | 0.21 | 4.63 | 0.66 | 0.00 | 7.67 | 5.53 | 14.28 | 1.77 | 5.27 | 35.94 |
| 130 | 0.00 | 20.11 | 3.74 | 0.21 | 4.38 | 0.66 | 0.28 | 7.61 | 5.12 | 14.70 | 1.75 | 6.62 | 34.81 |
| 131 | 0.00 | 19.42 | 3.77 | 0.21 | 6.38 | 0.66 | 0.00 | 4.51 | 4.06 | 16.44 | 1.77 | 5.26 | 35.92 |

| | Glass composition (% by mass) | | | | | | | | | |
|---|---|---|---|---|---|---|---|---|---|---|
| No. | ZnO | Y₂O₃ | La₂O₃ | Gd₂O₃ | Ta₂O₅ | Bi₂O₃ | Yb₂O₃ | WO₃ | Total | Sb₂O₃ |
| 1 | 0.00 | 0.00 | 0.00 | 0.00 | 0.00 | 0.00 | 0.00 | 0.00 | 100.00 | 0.02 |
| 2 | 0.00 | 0.00 | 0.00 | 0.00 | 0.00 | 0.00 | 0.00 | 0.00 | 100.00 | 0.02 |
| 3 | 0.00 | 0.00 | 0.00 | 0.00 | 0.00 | 0.00 | 0.00 | 0.00 | 100.00 | 0.02 |
| 4 | 0.00 | 0.00 | 0.00 | 0.00 | 0.00 | 0.00 | 0.00 | 0.00 | 100.00 | 0.02 |
| 5 | 0.00 | 0.00 | 0.00 | 0.00 | 0.00 | 0.00 | 0.00 | 0.00 | 100.00 | 0.02 |
| 6 | 0.00 | 0.00 | 0.00 | 0.00 | 0.00 | 0.00 | 0.00 | 0.00 | 100.00 | 0.02 |
| 7 | 3.39 | 0.00 | 0.00 | 0.00 | 0.00 | 0.00 | 0.00 | 0.00 | 100.00 | 0.02 |
| 8 | 0.00 | 0.00 | 0.00 | 0.00 | 0.00 | 0.00 | 0.00 | 0.00 | 100.00 | 0.02 |
| 9 | 0.00 | 0.00 | 0.00 | 0.00 | 0.00 | 0.00 | 0.00 | 0.00 | 100.00 | 0.02 |
| 10 | 0.00 | 0.00 | 0.00 | 0.00 | 0.00 | 0.00 | 0.00 | 0.00 | 100.00 | 0.02 |
| 11 | 0.00 | 0.00 | 0.00 | 0.00 | 0.00 | 0.00 | 0.00 | 0.00 | 100.00 | 0.02 |
| 12 | 0.00 | 0.00 | 0.00 | 0.00 | 0.00 | 0.00 | 0.00 | 0.00 | 100.00 | 0.02 |
| 13 | 0.00 | 0.00 | 0.00 | 0.00 | 0.00 | 0.00 | 0.00 | 0.00 | 100.00 | 0.02 |
| 14 | 0.00 | 0.00 | 0.00 | 0.00 | 0.00 | 0.00 | 0.00 | 0.00 | 100.00 | 0.02 |
| 15 | 0.00 | 0.00 | 0.00 | 0.00 | 0.00 | 0.00 | 0.00 | 0.00 | 100.00 | 0.02 |
| 16 | 0.00 | 0.00 | 0.00 | 0.00 | 0.00 | 0.00 | 0.00 | 0.00 | 100.00 | 0.02 |
| 17 | 0.00 | 0.00 | 0.00 | 0.00 | 0.00 | 0.00 | 0.00 | 0.00 | 100.00 | 0.02 |
| 18 | 0.00 | 0.00 | 0.00 | 0.00 | 0.00 | 0.00 | 0.00 | 0.00 | 100.00 | 0.02 |
| 19 | 0.00 | 0.00 | 0.00 | 0.00 | 0.00 | 0.00 | 0.00 | 0.00 | 100.00 | 0.02 |
| 20 | 0.00 | 0.00 | 0.00 | 0.00 | 0.00 | 0.00 | 0.00 | 0.00 | 100.00 | 0.02 |
| 21 | 0.00 | 0.00 | 0.00 | 0.00 | 0.00 | 0.00 | 0.00 | 0.00 | 100.00 | 0.02 |
| 22 | 0.00 | 0.00 | 0.00 | 0.00 | 0.00 | 0.00 | 0.00 | 0.00 | 100.00 | 0.02 |
| 23 | 0.00 | 0.00 | 0.00 | 0.00 | 0.00 | 0.00 | 0.00 | 0.00 | 100.00 | 0.02 |
| 24 | 0.00 | 0.00 | 0.00 | 0.00 | 0.00 | 0.00 | 0.00 | 0.00 | 100.00 | 0.02 |
| 25 | 0.00 | 1.61 | 0.00 | 0.00 | 0.00 | 0.00 | 0.00 | 0.00 | 100.00 | 0.02 |
| 26 | 0.00 | 3.22 | 0.00 | 0.00 | 0.00 | 0.00 | 0.00 | 0.00 | 100.00 | 0.02 |
| 27 | 0.00 | 4.85 | 0.00 | 0.00 | 0.00 | 0.00 | 0.00 | 0.00 | 100.00 | 0.02 |
| 28 | 0.00 | 0.00 | 0.00 | 0.00 | 0.00 | 0.00 | 0.00 | 0.00 | 100.00 | 0.02 |
| 29 | 0.00 | 0.00 | 0.00 | 0.00 | 0.00 | 0.00 | 0.00 | 0.00 | 100.00 | 0.02 |
| 30 | 0.00 | 0.00 | 0.00 | 0.00 | 0.00 | 0.00 | 0.00 | 0.00 | 100.00 | 0.02 |
| 31 | 0.00 | 0.00 | 0.00 | 0.00 | 0.00 | 0.00 | 0.00 | 0.00 | 100.00 | 0.02 |
| 32 | 0.00 | 0.00 | 0.00 | 0.00 | 0.00 | 0.00 | 0.00 | 0.00 | 100.00 | 0.02 |
| 33 | 0.00 | 0.00 | 0.00 | 0.00 | 0.00 | 0.00 | 0.00 | 0.00 | 100.00 | 0.02 |
| 34 | 0.00 | 0.00 | 0.00 | 0.00 | 0.00 | 0.00 | 0.00 | 0.00 | 100.00 | 0.02 |
| 35 | 0.00 | 0.00 | 0.00 | 0.00 | 0.00 | 0.00 | 0.00 | 0.00 | 100.00 | 0.02 |
| 36 | 0.00 | 0.00 | 0.00 | 0.00 | 0.00 | 0.00 | 0.00 | 0.00 | 100.00 | 0.02 |
| 37 | 0.00 | 0.00 | 2.32 | 0.00 | 0.00 | 0.00 | 0.00 | 0.00 | 100.00 | 0.02 |
| 38 | 0.00 | 0.00 | 4.62 | 0.00 | 0.00 | 0.00 | 0.00 | 0.00 | 100.00 | 0.02 |
| 39 | 1.16 | 0.00 | 0.00 | 0.00 | 0.00 | 0.00 | 0.00 | 0.00 | 100.00 | 0.02 |
| 40 | 2.33 | 0.00 | 0.00 | 0.00 | 0.00 | 0.00 | 0.00 | 0.00 | 100.00 | 0.02 |
| 41 | 0.00 | 3.21 | 0.00 | 0.00 | 0.00 | 0.00 | 0.00 | 0.00 | 100.00 | 0.02 |
| 42 | 1.17 | 0.00 | 0.00 | 0.00 | 0.00 | 0.00 | 0.00 | 0.00 | 100.00 | 0.02 |
| 43 | 2.37 | 0.00 | 0.00 | 0.00 | 0.00 | 0.00 | 0.00 | 0.00 | 100.00 | 0.02 |
| 44 | 0.00 | 1.62 | 0.00 | 0.00 | 0.00 | 0.00 | 0.00 | 0.00 | 100.00 | 0.02 |
| 45 | 0.00 | 3.25 | 0.00 | 0.00 | 0.00 | 0.00 | 0.00 | 0.00 | 100.00 | 0.02 |
| 46 | 0.00 | 0.00 | 0.00 | 0.00 | 0.00 | 0.00 | 0.00 | 0.00 | 100.00 | 0.02 |
| 47 | 0.00 | 0.00 | 0.00 | 0.00 | 0.00 | 0.00 | 0.00 | 0.00 | 100.00 | 0.02 |
| 48 | 0.00 | 0.00 | 0.00 | 0.00 | 0.00 | 0.00 | 0.00 | 0.00 | 100.00 | 0.02 |
| 49 | 0.00 | 0.00 | 0.00 | 0.00 | 0.00 | 0.00 | 0.00 | 0.00 | 100.00 | 0.02 |
| 50 | 0.00 | 0.00 | 0.00 | 0.00 | 0.00 | 0.00 | 0.00 | 0.00 | 100.00 | 0.02 |
| 51 | 0.00 | 0.00 | 0.00 | 0.00 | 0.00 | 0.00 | 0.00 | 0.00 | 100.00 | 0.02 |
| 52 | 0.00 | 0.00 | 0.00 | 0.00 | 0.00 | 0.00 | 0.00 | 0.00 | 100.00 | 0.02 |
| 53 | 0.00 | 0.00 | 0.00 | 0.00 | 0.00 | 0.00 | 0.00 | 0.00 | 100.00 | 0.02 |
| 54 | 0.00 | 0.00 | 0.00 | 0.00 | 0.00 | 0.00 | 0.00 | 0.00 | 100.00 | 0.02 |
| 55 | 0.00 | 0.00 | 0.00 | 0.00 | 0.00 | 0.00 | 0.00 | 0.00 | 100.00 | 0.02 |
| 56 | 0.00 | 0.00 | 0.00 | 0.00 | 0.00 | 0.00 | 0.00 | 0.00 | 100.00 | 0.02 |
| 57 | 0.00 | 0.00 | 0.00 | 0.00 | 0.00 | 0.00 | 0.00 | 0.00 | 100.00 | 0.02 |
| 58 | 0.00 | 0.00 | 0.00 | 0.00 | 0.00 | 0.00 | 0.00 | 0.00 | 100.00 | 0.02 |
| 59 | 0.00 | 0.00 | 0.00 | 0.00 | 0.00 | 0.00 | 0.00 | 0.00 | 100.00 | 0.02 |
| 60 | 0.00 | 0.00 | 0.00 | 0.00 | 0.00 | 0.00 | 0.00 | 0.00 | 100.00 | 0.02 |
| 61 | 0.00 | 0.00 | 0.00 | 0.00 | 0.00 | 0.00 | 0.00 | 0.00 | 100.00 | 0.02 |
| 62 | 0.00 | 0.00 | 0.00 | 0.00 | 0.00 | 0.00 | 0.00 | 0.00 | 100.00 | 0.02 |
| 63 | 0.00 | 0.00 | 0.00 | 0.00 | 0.00 | 0.00 | 0.00 | 0.00 | 100.00 | 0.02 |
| 64 | 0.00 | 0.00 | 0.00 | 0.00 | 0.00 | 0.00 | 0.00 | 0.00 | 100.00 | 0.02 |
| 65 | 0.00 | 0.00 | 0.00 | 0.00 | 0.00 | 0.00 | 0.00 | 0.00 | 100.00 | 0.02 |
| 66 | 0.00 | 0.00 | 0.00 | 0.00 | 0.00 | 0.00 | 0.00 | 0.00 | 100.00 | 0.02 |
| 67 | 0.00 | 0.00 | 0.00 | 0.00 | 0.00 | 0.00 | 0.00 | 0.00 | 100.00 | 0.02 |
| 68 | 0.00 | 0.00 | 0.00 | 0.00 | 0.00 | 0.00 | 0.00 | 0.00 | 100.00 | 0.02 |
| 69 | 0.00 | 0.00 | 0.00 | 0.00 | 0.00 | 0.00 | 0.00 | 0.00 | 100.00 | 0.02 |
| 70 | 0.00 | 0.00 | 0.00 | 0.00 | 0.00 | 0.00 | 0.00 | 0.00 | 100.00 | 0.02 |
| 71 | 0.00 | 0.00 | 0.00 | 0.00 | 0.00 | 0.00 | 0.00 | 0.00 | 100.00 | 0.02 |
| 72 | 0.00 | 0.00 | 0.00 | 0.00 | 0.00 | 0.00 | 0.00 | 0.00 | 100.00 | 0.02 |
| 73 | 0.00 | 0.00 | 0.00 | 0.00 | 0.00 | 0.00 | 0.00 | 0.00 | 100.00 | 0.02 |
| 74 | 0.00 | 0.00 | 0.00 | 0.00 | 0.00 | 0.00 | 0.00 | 0.00 | 100.00 | 0.02 |
| 75 | 0.00 | 0.00 | 0.00 | 0.00 | 0.00 | 0.00 | 0.00 | 0.00 | 100.00 | 0.02 |
| 76 | 0.00 | 0.00 | 0.00 | 0.00 | 0.00 | 0.00 | 0.00 | 0.00 | 100.00 | 0.02 |
| 77 | 0.00 | 0.00 | 0.00 | 0.00 | 0.00 | 0.00 | 0.00 | 0.00 | 100.00 | 0.02 |
| 78 | 0.00 | 0.00 | 0.00 | 0.00 | 0.00 | 0.00 | 0.00 | 0.00 | 100.00 | 0.02 |
| 79 | 0.00 | 0.00 | 0.00 | 0.00 | 0.00 | 0.00 | 0.00 | 0.00 | 100.00 | 0.02 |
| 80 | 0.00 | 0.00 | 0.00 | 0.00 | 0.00 | 0.00 | 0.00 | 0.00 | 100.00 | 0.02 |
| 81 | 0.00 | 0.00 | 0.00 | 0.00 | 0.00 | 0.00 | 0.00 | 0.00 | 100.00 | 0.02 |
| 82 | 0.00 | 0.00 | 0.00 | 0.00 | 0.00 | 0.00 | 0.00 | 0.00 | 100.00 | 0.02 |
| 83 | 0.00 | 0.00 | 0.00 | 0.00 | 0.00 | 0.00 | 0.00 | 0.00 | 100.00 | 0.02 |
| 84 | 0.00 | 0.00 | 0.00 | 0.00 | 0.00 | 0.00 | 0.00 | 0.00 | 100.00 | 0.02 |
| 85 | 0.00 | 0.00 | 0.00 | 0.00 | 0.00 | 0.00 | 0.00 | 0.00 | 100.00 | 0.02 |
| 86 | 0.00 | 0.00 | 0.00 | 0.00 | 0.00 | 0.00 | 0.00 | 0.00 | 100.00 | 0.02 |
| 87 | 0.00 | 0.00 | 0.00 | 0.00 | 0.00 | 0.00 | 0.00 | 0.00 | 100.00 | 0.02 |
| 88 | 0.00 | 0.00 | 0.00 | 0.00 | 0.00 | 0.00 | 0.00 | 0.00 | 100.00 | 0.02 |
| 89 | 0.00 | 0.00 | 0.00 | 0.00 | 0.00 | 0.00 | 0.00 | 0.00 | 100.00 | 0.02 |
| 90 | 0.00 | 0.00 | 0.00 | 0.00 | 0.00 | 0.00 | 0.00 | 0.00 | 100.00 | 0.02 |
| 91 | 0.00 | 0.00 | 0.00 | 0.00 | 0.00 | 0.00 | 0.00 | 0.00 | 100.00 | 0.02 |
| 92 | 0.00 | 0.00 | 0.00 | 0.00 | 0.00 | 0.00 | 0.00 | 0.00 | 100.00 | 0.02 |
| 93 | 0.00 | 0.00 | 0.00 | 0.00 | 0.00 | 0.00 | 0.00 | 0.00 | 100.00 | 0.02 |
| 94 | 0.00 | 0.00 | 0.00 | 0.00 | 0.00 | 0.00 | 0.00 | 0.00 | 100.00 | 0.02 |
| 95 | 0.00 | 0.00 | 0.00 | 0.00 | 0.00 | 0.00 | 0.00 | 0.00 | 100.00 | 0.02 |
| 96 | 0.00 | 0.00 | 0.00 | 0.00 | 0.00 | 0.00 | 0.00 | 0.00 | 100.00 | 0.02 |
| 97 | 0.00 | 0.00 | 0.00 | 0.00 | 0.00 | 0.00 | 0.00 | 0.00 | 100.00 | 0.02 |
| 98 | 0.00 | 0.00 | 0.00 | 0.00 | 0.00 | 0.00 | 0.00 | 0.00 | 100.00 | 0.02 |
| 99 | 0.00 | 0.00 | 0.00 | 0.00 | 0.00 | 0.00 | 0.00 | 0.00 | 100.00 | 0.02 |
| 100 | 0.00 | 0.00 | 0.00 | 0.00 | 0.00 | 0.00 | 0.00 | 0.00 | 100.00 | 0.02 |
| 101 | 0.00 | 0.00 | 0.00 | 0.00 | 0.00 | 0.00 | 0.00 | 0.00 | 100.00 | 0.02 |
| 102 | 0.00 | 0.00 | 0.00 | 0.00 | 0.00 | 0.00 | 0.00 | 0.00 | 100.00 | 0.02 |
| 103 | 0.00 | 0.00 | 0.00 | 0.00 | 0.00 | 0.00 | 0.00 | 0.00 | 100.00 | 0.02 |
| 104 | 0.00 | 0.00 | 0.00 | 0.00 | 0.00 | 0.00 | 0.00 | 0.00 | 100.00 | 0.02 |
| 105 | 0.00 | 0.00 | 0.00 | 0.00 | 0.00 | 0.00 | 0.00 | 0.00 | 100.00 | 0.02 |
| 106 | 0.00 | 0.00 | 0.00 | 0.00 | 0.00 | 0.00 | 0.00 | 0.00 | 100.00 | 0.02 |
| 107 | 0.00 | 0.00 | 0.00 | 0.00 | 0.00 | 0.00 | 0.00 | 0.00 | 100.00 | 0.02 |
| 108 | 0.00 | 0.00 | 0.00 | 0.00 | 0.00 | 0.00 | 0.00 | 0.00 | 100.00 | 0.02 |
| 109 | 0.00 | 0.00 | 0.00 | 0.00 | 0.00 | 0.00 | 0.00 | 0.00 | 100.00 | 0.02 |
| 110 | 0.00 | 0.00 | 0.00 | 0.00 | 0.00 | 0.00 | 0.00 | 0.00 | 100.00 | 0.02 |
| 111 | 0.00 | 0.00 | 0.00 | 0.00 | 0.00 | 0.00 | 0.00 | 0.00 | 100.00 | 0.02 |
| 112 | 0.00 | 0.00 | 0.00 | 0.00 | 0.00 | 0.00 | 0.00 | 0.00 | 100.00 | 0.02 |
| 113 | 0.00 | 0.00 | 0.00 | 0.00 | 0.00 | 0.00 | 0.00 | 0.00 | 100.00 | 0.02 |
| 114 | 0.00 | 0.00 | 0.00 | 0.00 | 0.00 | 0.00 | 0.00 | 0.00 | 100.00 | 0.02 |
| 115 | 0.00 | 0.00 | 0.00 | 0.00 | 0.00 | 0.00 | 0.00 | 0.00 | 100.00 | 0.02 |
| 116 | 0.00 | 0.00 | 0.00 | 0.00 | 0.00 | 0.00 | 0.00 | 0.00 | 100.00 | 0.02 |
| 117 | 0.00 | 0.00 | 0.00 | 0.00 | 0.00 | 0.00 | 0.00 | 0.00 | 100.00 | 0.02 |
| 118 | 0.00 | 0.00 | 0.00 | 0.00 | 0.00 | 0.00 | 0.00 | 0.00 | 100.00 | 0.02 |
| 119 | 0.00 | 0.00 | 0.00 | 0.00 | 0.00 | 0.00 | 0.00 | 0.00 | 100.00 | 0.02 |
| 120 | 0.00 | 0.00 | 0.00 | 0.00 | 0.00 | 0.00 | 0.00 | 0.00 | 100.00 | 0.02 |
| 121 | 0.00 | 0.00 | 0.00 | 0.00 | 0.00 | 0.00 | 0.00 | 0.00 | 100.00 | 0.02 |
| 122 | 0.00 | 0.00 | 0.00 | 0.00 | 0.00 | 0.00 | 0.00 | 0.00 | 100.00 | 0.02 |
| 123 | 0.00 | 0.00 | 0.00 | 0.00 | 0.00 | 0.00 | 0.00 | 0.00 | 100.00 | 0.02 |
| 124 | 0.00 | 0.00 | 0.00 | 0.00 | 0.00 | 0.00 | 0.00 | 0.00 | 100.00 | 0.02 |
| 125 | 0.00 | 0.00 | 0.00 | 0.00 | 0.00 | 0.00 | 0.00 | 0.00 | 100.00 | 0.02 |
| 126 | 0.00 | 0.00 | 0.00 | 0.00 | 0.00 | 0.00 | 0.00 | 0.00 | 100.00 | 0.02 |
| 127 | 0.00 | 0.00 | 0.00 | 0.00 | 0.00 | 0.00 | 0.00 | 0.00 | 100.00 | 0.02 |
| 128 | 0.00 | 0.00 | 0.00 | 0.00 | 0.00 | 0.00 | 0.00 | 0.00 | 100.00 | 0.02 |
| 129 | 0.00 | 0.00 | 0.00 | 0.00 | 0.00 | 0.00 | 0.00 | 0.00 | 100.00 | 0.02 |
| 130 | 0.00 | 0.00 | 0.00 | 0.00 | 0.00 | 0.00 | 0.00 | 0.00 | 100.00 | 0.02 |
| 131 | 0.00 | 1.59 | 0.00 | 0.00 | 0.00 | 0.00 | 0.00 | 0.00 | 100.00 | 0.02 |

TABLE 2

| | Glass composition (% by mass) | | | | | | |
|---|---|---|---|---|---|---|---|
| | LiO₂ + Na₂O + | Li₂O/(Li₂O + | K₂O/(Li₂O + | (Li₂O + Na₂O + K₂O)/ | MgO + CaO + | BaO/(MgO + | TiO₂ + |
| No. | K₂O | Na₂O + K₂O) | Na₂O + K₂O) | (MgO + CaO + SrO + BaO) | SrO + BaO | CaO + SrO + BaO) | Nb₂O₅ |
| 1 | 4.01 | 0.00 | 0.00 | 0.13 | 29.74 | 0.6189 | 41.22 |
| 2 | 4.20 | 0.00 | 0.00 | 0.16 | 26.38 | 0.4848 | 43.20 |
| 3 | 4.17 | 0.00 | 0.00 | 0.16 | 26.87 | 0.4728 | 42.91 |
| 4 | 4.35 | 0.00 | 0.00 | 0.18 | 23.74 | 0.2743 | 44.74 |
| 5 | 4.09 | 0.00 | 0.00 | 0.14 | 28.30 | 0.4400 | 42.07 |
| 6 | 4.18 | 0.00 | 0.00 | 0.16 | 26.80 | 0.2333 | 42.95 |
| 7 | 4.13 | 0.00 | 0.00 | 0.17 | 24.25 | 0.5184 | 42.46 |
| 8 | 4.01 | 0.00 | 0.00 | 0.13 | 29.76 | 0.6189 | 40.35 |
| 9 | 4.02 | 0.00 | 0.00 | 0.13 | 29.78 | 0.6189 | 39.48 |
| 10 | 4.12 | 0.00 | 0.00 | 0.15 | 27.81 | 0.3745 | 42.36 |
| 11 | 4.15 | 0.00 | 0.00 | 0.15 | 27.31 | 0.3057 | 42.65 |
| 12 | 4.14 | 0.00 | 0.00 | 0.16 | 26.45 | 0.5573 | 42.58 |
| 13 | 4.19 | 0.00 | 0.00 | 0.16 | 25.43 | 0.2467 | 44.22 |
| 14 | 4.24 | 0.00 | 0.00 | 0.18 | 23.51 | 0.1767 | 45.82 |
| 15 | 4.66 | 0.00 | 0.00 | 0.18 | 25.60 | 0.2467 | 43.39 |
| 16 | 5.19 | 0.00 | 0.00 | 0.22 | 23.84 | 0.1767 | 44.16 |
| 17 | 4.21 | 0.00 | 0.00 | 0.16 | 26.31 | 0.2392 | 43.24 |
| 18 | 4.27 | 0.00 | 0.00 | 0.17 | 25.28 | 0.1654 | 43.84 |
| 19 | 4.70 | 0.00 | 0.00 | 0.18 | 25.80 | 0.2467 | 42.96 |
| 20 | 4.04 | 0.00 | 0.00 | 0.14 | 29.29 | 0.6324 | 41.49 |
| 21 | 5.32 | 0.00 | 0.00 | 0.19 | 27.76 | 0.6700 | 41.64 |
| 22 | 4.67 | 0.00 | 0.00 | 0.18 | 25.64 | 0.2467 | 41.56 |
| 23 | 4.67 | 0.00 | 0.00 | 0.18 | 25.67 | 0.2467 | 39.73 |
| 24 | 4.68 | 0.00 | 0.00 | 0.18 | 25.71 | 0.2467 | 37.89 |
| 25 | 4.67 | 0.00 | 0.00 | 0.18 | 25.68 | 0.2467 | 41.62 |
| 26 | 4.69 | 0.00 | 0.00 | 0.18 | 25.75 | 0.2467 | 39.84 |
| 27 | 4.70 | 0.00 | 0.00 | 0.18 | 25.82 | 0.2467 | 38.06 |
| 28 | 6.01 | 0.00 | 0.22 | 0.25 | 24.07 | 0.2630 | 43.50 |
| 29 | 7.37 | 0.00 | 0.36 | 0.33 | 22.53 | 0.2817 | 43.61 |
| 30 | 6.10 | 0.00 | 0.22 | 0.26 | 23.03 | 0.2787 | 44.10 |
| 31 | 7.58 | 0.00 | 0.36 | 0.37 | 20.37 | 0.3203 | 44.83 |
| 32 | 5.53 | 0.00 | 0.48 | 0.22 | 25.37 | 0.2467 | 43.00 |
| 33 | 5.58 | 0.00 | 0.00 | 0.23 | 24.18 | 0.2630 | 43.70 |
| 34 | 6.51 | 0.00 | 0.00 | 0.29 | 22.74 | 0.2817 | 44.02 |
| 35 | 5.66 | 0.00 | 0.00 | 0.24 | 23.14 | 0.2787 | 44.31 |
| 36 | 6.70 | 0.00 | 0.00 | 0.33 | 20.57 | 0.3203 | 45.26 |
| 37 | 6.01 | 0.00 | 0.22 | 0.27 | 21.86 | 0.1895 | 43.44 |
| 38 | 6.00 | 0.00 | 0.22 | 0.31 | 19.65 | 0.0998 | 43.38 |
| 39 | 6.03 | 0.00 | 0.22 | 0.27 | 22.67 | 0.2802 | 43.64 |
| 40 | 6.05 | 0.00 | 0.22 | 0.28 | 21.26 | 0.2997 | 43.78 |
| 41 | 6.00 | 0.00 | 0.22 | 0.28 | 21.07 | 0.2997 | 43.39 |
| 42 | 6.08 | 0.00 | 0.22 | 0.27 | 22.12 | 0.1895 | 43.95 |
| 43 | 6.14 | 0.00 | 0.22 | 0.31 | 20.12 | 0.0998 | 44.41 |
| 44 | 6.05 | 0.00 | 0.22 | 0.27 | 22.02 | 0.1895 | 43.75 |
| 45 | 6.08 | 0.00 | 0.22 | 0.31 | 19.94 | 0.0998 | 44.01 |
| 46 | 6.03 | 0.00 | 0.22 | 0.27 | 22.67 | 0.2802 | 44.79 |
| 47 | 5.99 | 0.00 | 0.22 | 0.26 | 23.20 | 0.2720 | 44.49 |
| 48 | 6.03 | 0.00 | 0.22 | 0.26 | 23.03 | 0.2280 | 43.60 |
| 49 | 6.04 | 0.00 | 0.22 | 0.27 | 21.99 | 0.1895 | 43.69 |
| 50 | 6.01 | 0.00 | 0.22 | 0.26 | 23.30 | 0.2713 | 43.44 |
| 51 | 6.00 | 0.00 | 0.22 | 0.27 | 22.54 | 0.2802 | 43.38 |
| 52 | 6.10 | 0.00 | 0.22 | 0.25 | 24.42 | 0.2630 | 44.14 |
| 53 | 6.06 | 0.00 | 0.22 | 0.25 | 24.25 | 0.2630 | 43.82 |
| 54 | 5.97 | 0.00 | 0.22 | 0.25 | 23.90 | 0.2630 | 43.19 |
| 55 | 5.93 | 0.00 | 0.22 | 0.25 | 23.73 | 0.2630 | 42.89 |
| 56 | 6.03 | 0.00 | 0.22 | 0.25 | 24.15 | 0.2630 | 44.21 |
| 57 | 6.05 | 0.00 | 0.22 | 0.25 | 24.23 | 0.2630 | 44.94 |
| 58 | 6.01 | 0.00 | 0.22 | 0.25 | 24.06 | 0.2630 | 44.42 |
| 59 | 6.01 | 0.00 | 0.22 | 0.25 | 24.04 | 0.2630 | 45.36 |
| 60 | 4.69 | 0.00 | 0.00 | 0.19 | 24.16 | 0.2630 | 43.66 |
| 61 | 6.02 | 0.00 | 0.22 | 0.25 | 24.12 | 0.2630 | 43.58 |
| 62 | 6.04 | 0.00 | 0.22 | 0.25 | 24.16 | 0.2630 | 43.66 |
| 63 | 6.08 | 0.00 | 0.22 | 0.25 | 24.34 | 0.2630 | 43.98 |
| 64 | 3.94 | 0.43 | 0.00 | 0.14 | 28.71 | 0.6189 | 45.31 |
| 65 | 4.66 | 0.00 | 0.00 | 0.18 | 25.99 | 0.2432 | 43.42 |
| 66 | 4.67 | 0.00 | 0.00 | 0.18 | 26.38 | 0.2398 | 43.45 |
| 67 | 4.67 | 0.00 | 0.00 | 0.17 | 26.76 | 0.2365 | 43.48 |
| 68 | 4.67 | 0.00 | 0.00 | 0.17 | 27.18 | 0.2330 | 43.52 |
| 69 | 4.67 | 0.00 | 0.00 | 0.18 | 26.25 | 0.2413 | 43.51 |
| 70 | 4.69 | 0.00 | 0.00 | 0.17 | 26.90 | 0.2361 | 43.64 |
| 71 | 4.66 | 0.00 | 0.00 | 0.18 | 26.42 | 0.2392 | 43.42 |
| 72 | 4.67 | 0.00 | 0.00 | 0.17 | 27.23 | 0.2322 | 43.44 |
| 73 | 4.68 | 0.00 | 0.00 | 0.18 | 25.69 | 0.2467 | 41.45 |
| 74 | 4.69 | 0.00 | 0.00 | 0.18 | 25.74 | 0.2467 | 41.34 |
| 75 | 4.69 | 0.00 | 0.00 | 0.18 | 25.79 | 0.2467 | 41.23 |
| 76 | 4.70 | 0.00 | 0.00 | 0.18 | 25.83 | 0.2467 | 41.12 |
| 77 | 5.72 | 0.00 | 0.18 | 0.23 | 24.63 | 0.2587 | 43.79 |
| 78 | 5.38 | 0.00 | 0.13 | 0.21 | 25.02 | 0.2546 | 43.76 |
| 79 | 5.04 | 0.00 | 0.07 | 0.20 | 25.40 | 0.2506 | 43.73 |
| 80 | 4.70 | 0.00 | 0.00 | 0.18 | 25.79 | 0.2467 | 43.71 |
| 81 | 6.06 | 0.00 | 0.22 | 0.25 | 24.25 | 0.2630 | 43.45 |
| 82 | 6.08 | 0.00 | 0.22 | 0.25 | 24.34 | 0.2630 | 43.23 |
| 83 | 5.82 | 0.04 | 0.23 | 0.24 | 24.22 | 0.2630 | 43.76 |
| 84 | 5.60 | 0.08 | 0.24 | 0.23 | 24.27 | 0.2630 | 43.86 |
| 85 | 5.39 | 0.12 | 0.25 | 0.22 | 24.33 | 0.2630 | 43.96 |
| 86 | 5.17 | 0.17 | 0.26 | 0.21 | 24.38 | 0.2630 | 44.06 |
| 87 | 5.99 | 0.00 | 0.22 | 0.24 | 24.69 | 0.3436 | 43.35 |
| 88 | 5.95 | 0.00 | 0.22 | 0.24 | 25.22 | 0.4197 | 43.05 |
| 89 | 5.91 | 0.00 | 0.22 | 0.23 | 25.74 | 0.4916 | 42.75 |
| 90 | 5.95 | 0.00 | 0.22 | 0.24 | 25.20 | 0.3344 | 43.06 |
| 91 | 5.79 | 0.00 | 0.22 | 0.21 | 27.19 | 0.4563 | 41.91 |
| 92 | 6.00 | 0.00 | 0.22 | 0.24 | 24.67 | 0.2558 | 43.37 |
| 93 | 5.95 | 0.00 | 0.22 | 0.24 | 25.18 | 0.2490 | 43.07 |
| 94 | 5.54 | 0.00 | 0.24 | 0.22 | 25.38 | 0.2478 | 43.21 |
| 95 | 5.05 | 0.00 | 0.26 | 0.19 | 26.57 | 0.2343 | 42.77 |
| 96 | 5.98 | 0.00 | 0.22 | 0.27 | 22.48 | 0.2802 | 42.14 |
| 97 | 5.93 | 0.00 | 0.22 | 0.28 | 20.83 | 0.2997 | 40.65 |
| 98 | 5.94 | 0.00 | 0.22 | 0.26 | 23.00 | 0.2720 | 41.86 |
| 99 | 6.48 | 0.07 | 0.21 | 0.25 | 26.41 | 0.3243 | 42.62 |
| 100 | 5.11 | 0.08 | 0.00 | 0.19 | 26.32 | 0.3243 | 42.46 |
| 101 | 5.11 | 0.17 | 0.26 | 0.19 | 26.32 | 0.3243 | 42.46 |
| 102 | 6.04 | 0.00 | 0.22 | 0.23 | 26.36 | 0.3243 | 42.53 |
| 103 | 4.66 | 0.00 | 0.00 | 0.18 | 26.17 | 0.3243 | 42.22 |
| 104 | 5.08 | 0.00 | 0.00 | 0.19 | 26.90 | 0.3147 | 42.12 |
| 105 | 4.63 | 0.00 | 0.00 | 0.17 | 27.59 | 0.3057 | 41.97 |
| 106 | 5.98 | 0.00 | 0.22 | 0.22 | 27.69 | 0.3057 | 42.13 |
| 107 | 5.13 | 0.08 | 0.00 | 0.19 | 27.28 | 0.3460 | 41.39 |
| 108 | 5.63 | 0.14 | 0.00 | 0.23 | 24.91 | 0.2630 | 42.51 |
| 109 | 4.68 | 0.18 | 0.00 | 0.16 | 28.68 | 0.3761 | 40.36 |
| 110 | 4.67 | 0.18 | 0.00 | 0.16 | 28.59 | 0.3761 | 40.55 |
| 111 | 4.23 | 0.30 | 0.00 | 0.14 | 30.09 | 0.4036 | 39.33 |
| 112 | 4.23 | 0.20 | 0.00 | 0.14 | 29.22 | 0.3687 | 40.31 |
| 113 | 4.68 | 0.18 | 0.00 | 0.17 | 28.29 | 0.3815 | 40.38 |
| 114 | 5.06 | 0.08 | 0.00 | 0.18 | 28.30 | 0.4818 | 40.81 |
| 115 | 5.07 | 0.08 | 0.00 | 0.18 | 28.41 | 0.4818 | 40.59 |
| 116 | 5.09 | 0.08 | 0.00 | 0.18 | 28.52 | 0.4818 | 40.36 |
| 117 | 5.11 | 0.08 | 0.00 | 0.18 | 28.62 | 0.4818 | 40.14 |
| 118 | 4.90 | 0.09 | 0.00 | 0.18 | 27.55 | 0.3424 | 41.36 |
| 119 | 4.68 | 0.09 | 0.00 | 0.17 | 27.82 | 0.3389 | 41.34 |
| 120 | 4.45 | 0.10 | 0.00 | 0.16 | 28.09 | 0.3354 | 41.31 |
| 121 | 4.23 | 0.10 | 0.00 | 0.15 | 28.36 | 0.3320 | 41.28 |
| 122 | 4.61 | 0.09 | 0.00 | 0.16 | 28.83 | 0.4723 | 40.76 |
| 123 | 4.60 | 0.09 | 0.00 | 0.16 | 29.08 | 0.5036 | 40.61 |
| 124 | 4.58 | 0.09 | 0.00 | 0.16 | 29.33 | 0.5343 | 40.47 |
| 125 | 4.61 | 0.09 | 0.00 | 0.16 | 29.19 | 0.5036 | 40.39 |
| 126 | 4.63 | 0.09 | 0.00 | 0.16 | 29.30 | 0.5036 | 40.17 |
| 127 | 5.89 | 0.00 | 0.22 | 0.22 | 26.35 | 0.5598 | 42.24 |
| 128 | 4.85 | 0.09 | 0.00 | 0.17 | 28.86 | 0.4929 | 40.38 |
| 129 | 5.51 | 0.04 | 0.12 | 0.20 | 27.47 | 0.5197 | 41.20 |
| 130 | 5.25 | 0.04 | 0.13 | 0.19 | 27.71 | 0.5305 | 41.43 |
| 131 | 7.25 | 0.03 | 0.09 | 0.29 | 25.00 | 0.6573 | 41.19 |

TABLE 3

| | Glass composition (% by mass) | | | | |
|---|---|---|---|---|---|
| | (TiO₂ + Nb₂O₅ + Y₂O₃ + | | | | |
| | ZrO₂ + La₂O + Gd₂O₃ + | | TiO₂/(TiO₂ + Nb₂O₅ + | Nb₂O₅/(TiO₂ + Nb₂O₅ + | |
| | Ta₂O₅ + WO₃ + Yb₂O₃ + | | Y₂O₃ + ZrO₂ + La₂O + | Y₂O₃ + ZrO₂ + La₂O + | |
| | Bi₂O₃)/(BaO + SrO + | TiO₂/ | Gd₂O₃ + Ta₂O₅ + WO₃ + | Gd₂O₃ + Ta₂O₅ + WO₃ + | SiO₂/ |
| No. | CaO + MgO) | Nb₂O₅ | Yb₂O₃ + Bi₂O₃) | Yb₂O₃ + Bi₂O₃) | TiO₂ |
| 1 | 1.4428 | 4.3366 | 0.7806 | 0.1800 | 0.6029 |
| 2 | 1.7049 | 4.3366 | 0.7806 | 0.1800 | 0.6029 |
| 3 | 1.6627 | 4.3366 | 0.7806 | 0.1800 | 0.6029 |
| 4 | 1.9618 | 4.3366 | 0.7806 | 0.1800 | 0.6029 |
| 5 | 1.5474 | 4.3366 | 0.7806 | 0.1800 | 0.6029 |
| 6 | 1.6684 | 4.3366 | 0.7806 | 0.1800 | 0.6029 |
| 7 | 1.8230 | 4.3366 | 0.7806 | 0.1800 | 0.6029 |
| 8 | 1.4406 | 4.9058 | 0.7818 | 0.1594 | 0.6029 |
| 9 | 1.4384 | 5.6471 | 0.7830 | 0.1387 | 0.6029 |
| 10 | 1.5857 | 4.3366 | 0.7806 | 0.1800 | 0.6029 |
| 11 | 1.6260 | 4.3366 | 0.7806 | 0.1800 | 0.6029 |
| 12 | 1.6758 | 4.3366 | 0.7806 | 0.1800 | 0.6029 |
| 13 | 1.8085 | 4.4761 | 0.7860 | 0.1756 | 0.5842 |
| 14 | 2.0250 | 4.6156 | 0.7911 | 0.1714 | 0.5665 |
| 15 | 1.7642 | 4.3366 | 0.7806 | 0.1800 | 0.6029 |
| 16 | 1.9282 | 4.3366 | 0.7806 | 0.1800 | 0.6029 |
| 17 | 1.7110 | 4.3366 | 0.7806 | 0.1800 | 0.6029 |
| 18 | 1.8054 | 4.3366 | 0.7806 | 0.1800 | 0.6029 |
| 19 | 1.7348 | 5.8287 | 0.8194 | 0.1406 | 0.5842 |
| 20 | 1.4744 | 4.3366 | 0.7806 | 0.1800 | 0.6029 |
| 21 | 1.5619 | 4.3366 | 0.7806 | 0.1800 | 0.6029 |
| 22 | 1.7589 | 5.6471 | 0.7830 | 0.1387 | 0.6029 |
| 23 | 1.7535 | 8.0925 | 0.7854 | 0.0971 | 0.6029 |
| 24 | 1.7481 | 14.2734 | 0.7878 | 0.0552 | 0.6029 |
| 25 | 1.7531 | 5.6471 | 0.7855 | 0.1391 | 0.6029 |
| 26 | 1.7421 | 8.0925 | 0.7905 | 0.0977 | 0.6029 |
| 27 | 1.7310 | 14.2734 | 0.7956 | 0.0557 | 0.6029 |
| 28 | 1.8812 | 4.3366 | 0.7806 | 0.1800 | 0.6029 |
| 29 | 2.0148 | 4.3366 | 0.7806 | 0.1800 | 0.6029 |
| 30 | 1.9933 | 4.3366 | 0.7806 | 0.1800 | 0.6029 |
| 31 | 2.2907 | 4.3366 | 0.7806 | 0.1800 | 0.6029 |
| 32 | 1.7642 | 4.3366 | 0.7806 | 0.1800 | 0.6029 |
| 33 | 1.8812 | 4.3366 | 0.7806 | 0.1800 | 0.6029 |
| 34 | 2.0148 | 4.3366 | 0.7806 | 0.1800 | 0.6029 |
| 35 | 1.9933 | 4.3366 | 0.7806 | 0.1800 | 0.6029 |
| 36 | 2.2907 | 4.3366 | 0.7806 | 0.1800 | 0.6029 |
| 37 | 2.1747 | 4.3366 | 0.7426 | 0.1712 | 0.6029 |
| 38 | 2.5331 | 4.3366 | 0.7081 | 0.1633 | 0.6029 |
| 39 | 2.0040 | 4.3366 | 0.7806 | 0.1800 | 0.6029 |
| 40 | 2.1439 | 4.3366 | 0.7806 | 0.1800 | 0.6029 |
| 41 | 2.2961 | 4.3366 | 0.7289 | 0.1681 | 0.6029 |
| 42 | 2.0688 | 4.3366 | 0.7806 | 0.1800 | 0.6029 |
| 43 | 2.2978 | 4.3366 | 0.7806 | 0.1800 | 0.6029 |
| 44 | 2.1422 | 4.3366 | 0.7539 | 0.1738 | 0.6029 |
| 45 | 2.4609 | 4.3366 | 0.7289 | 0.1681 | 0.6029 |
| 46 | 2.0543 | 4.4761 | 0.7860 | 0.1756 | 0.5842 |
| 47 | 1.9946 | 4.4761 | 0.7860 | 0.1756 | 0.5842 |
| 48 | 2.0087 | 4.3366 | 0.7658 | 0.1766 | 0.6029 |
| 49 | 2.1489 | 4.3366 | 0.7515 | 0.1733 | 0.6029 |
| 50 | 1.9783 | 4.3366 | 0.7658 | 0.1766 | 0.6029 |
| 51 | 2.0816 | 4.3366 | 0.7515 | 0.1733 | 0.6029 |
| 52 | 1.8812 | 4.3366 | 0.7806 | 0.1800 | 0.5062 |
| 53 | 1.8812 | 4.3366 | 0.7806 | 0.1800 | 0.5546 |
| 54 | 1.8812 | 4.3366 | 0.7806 | 0.1800 | 0.6513 |
| 55 | 1.8812 | 4.3366 | 0.7806 | 0.1800 | 0.6997 |
| 56 | 1.8684 | 4.4064 | 0.7986 | 0.1812 | 0.5934 |
| 57 | 1.8552 | 4.4785 | 0.8175 | 0.1825 | 0.5838 |
| 58 | 1.8841 | 3.8858 | 0.7794 | 0.2006 | 0.6029 |
| 59 | 1.8870 | 3.5084 | 0.7782 | 0.2218 | 0.6029 |
| 60 | 1.8812 | 4.3366 | 0.7806 | 0.1800 | 0.6029 |
| 61 | 1.8812 | 4.3366 | 0.7806 | 0.1800 | 0.5909 |
| 62 | 1.8812 | 4.3366 | 0.7806 | 0.1800 | 0.5788 |
| 63 | 1.8812 | 4.3366 | 0.7806 | 0.1800 | 0.5304 |
| 64 | 1.6351 | 1.1276 | 0.5116 | 0.4537 | 0.8118 |
| 65 | 1.7224 | 4.3366 | 0.7882 | 0.1818 | 0.6029 |
| 66 | 1.6818 | 4.3366 | 0.7960 | 0.1836 | 0.6029 |
| 67 | 1.6422 | 4.3366 | 0.8040 | 0.1854 | 0.6029 |
| 68 | 1.6011 | 4.3366 | 0.8126 | 0.1874 | 0.6029 |
| 69 | 1.7257 | 4.3366 | 0.7806 | 0.1800 | 0.5788 |
| 70 | 1.6888 | 4.3366 | 0.7806 | 0.1800 | 0.5546 |
| 71 | 1.7110 | 4.3366 | 0.7806 | 0.1800 | 0.5788 |
| 72 | 1.6609 | 4.3366 | 0.7806 | 0.1800 | 0.5546 |
| 73 | 1.7515 | 6.1577 | 0.7926 | 0.1287 | 0.5981 |
| 74 | 1.7442 | 6.7591 | 0.8023 | 0.1187 | 0.5934 |
| 75 | 1.7368 | 7.4781 | 0.8121 | 0.1086 | 0.5887 |
| 76 | 1.7295 | 8.3527 | 0.8219 | 0.0984 | 0.5842 |
| 77 | 1.8505 | 4.3366 | 0.7806 | 0.1800 | 0.5546 |
| 78 | 1.8209 | 4.3366 | 0.7806 | 0.1800 | 0.5546 |
| 79 | 1.7921 | 4.3366 | 0.7806 | 0.1800 | 0.5546 |
| 80 | 1.7642 | 4.3366 | 0.7806 | 0.1800 | 0.5546 |
| 81 | 1.8655 | 4.9847 | 0.7998 | 0.1605 | 0.5696 |
| 82 | 1.8499 | 5.8287 | 0.8194 | 0.1406 | 0.5607 |
| 83 | 1.8812 | 4.3366 | 0.7806 | 0.1800 | 0.5788 |
| 84 | 1.8812 | 4.3366 | 0.7806 | 0.1800 | 0.5788 |
| 85 | 1.8812 | 4.3366 | 0.7806 | 0.1800 | 0.5788 |
| 86 | 1.8812 | 4.3366 | 0.7806 | 0.1800 | 0.5788 |
| 87 | 1.8275 | 4.3366 | 0.7806 | 0.1800 | 0.5788 |
| 88 | 1.7768 | 4.3366 | 0.7806 | 0.1800 | 0.5788 |
| 89 | 1.7288 | 4.3366 | 0.7806 | 0.1800 | 0.5788 |
| 90 | 1.7789 | 4.3366 | 0.7806 | 0.1800 | 0.5788 |
| 91 | 1.6045 | 4.3366 | 0.7806 | 0.1800 | 0.5788 |
| 92 | 1.8298 | 4.3366 | 0.7806 | 0.1800 | 0.5788 |
| 93 | 1.7811 | 4.3366 | 0.7806 | 0.1800 | 0.5788 |
| 94 | 1.7726 | 4.3366 | 0.7806 | 0.1800 | 0.5788 |
| 95 | 1.6759 | 4.3366 | 0.7806 | 0.1800 | 0.5788 |
| 96 | 2.1089 | 4.1971 | 0.7179 | 0.1710 | 0.5980 |
| 97 | 2.3684 | 4.0577 | 0.6612 | 0.1629 | 0.6185 |
| 98 | 2.0476 | 4.1971 | 0.7179 | 0.1710 | 0.5980 |
| 99 | 1.6816 | 4.1971 | 0.7750 | 0.1846 | 0.5480 |
| 100 | 1.6816 | 4.1971 | 0.7750 | 0.1846 | 0.5980 |
| 101 | 1.6816 | 4.1971 | 0.7750 | 0.1846 | 0.5980 |
| 102 | 1.6816 | 4.1971 | 0.7750 | 0.1846 | 0.5230 |
| 103 | 1.6816 | 4.1971 | 0.7750 | 0.1846 | 0.5980 |
| 104 | 1.6319 | 4.1971 | 0.7750 | 0.1846 | 0.5980 |
| 105 | 1.5852 | 4.1971 | 0.7750 | 0.1846 | 0.5980 |
| 106 | 1.5852 | 4.1971 | 0.7750 | 0.1846 | 0.5480 |
| 107 | 1.5829 | 5.5744 | 0.8127 | 0.1458 | 0.5863 |
| 108 | 1.7806 | 5.1882 | 0.8035 | 0.1549 | 0.5940 |
| 109 | 1.4701 | 6.8089 | 0.8347 | 0.1226 | 0.5863 |
| 110 | 1.4807 | 5.8557 | 0.8179 | 0.1397 | 0.5940 |
| 111 | 1.3672 | 8.7458 | 0.8580 | 0.0981 | 0.5863 |
| 112 | 1.4410 | 6.8089 | 0.8347 | 0.1226 | 0.5863 |
| 113 | 1.4910 | 6.8089 | 0.8347 | 0.1226 | 0.5863 |
| 114 | 1.5044 | 5.5744 | 0.8127 | 0.1458 | 0.5863 |
| 115 | 1.4912 | 6.6735 | 0.8332 | 0.1249 | 0.5769 |
| 116 | 1.4780 | 8.2486 | 0.8542 | 0.1036 | 0.5678 |
| 117 | 1.4647 | 10.6943 | 0.8755 | 0.0819 | 0.5590 |
| 118 | 1.5663 | 5.5744 | 0.8127 | 0.1458 | 0.5863 |
| 119 | 1.5501 | 5.5744 | 0.8127 | 0.1458 | 0.5863 |
| 120 | 1.5342 | 5.5744 | 0.8127 | 0.1458 | 0.5863 |
| 121 | 1.5186 | 5.5744 | 0.8127 | 0.1458 | 0.5863 |
| 122 | 1.4748 | 5.5744 | 0.8127 | 0.1458 | 0.5863 |
| 123 | 1.4571 | 5.5744 | 0.8127 | 0.1458 | 0.5863 |
| 124 | 1.4398 | 5.5744 | 0.8127 | 0.1458 | 0.5863 |
| 125 | 1.4442 | 6.6735 | 0.8332 | 0.1249 | 0.5769 |
| 126 | 1.4314 | 8.2486 | 0.8542 | 0.1036 | 0.5678 |
| 127 | 1.6693 | 4.9847 | 0.7998 | 0.1605 | 0.5696 |
| 128 | 1.4608 | 7.3842 | 0.8436 | 0.1143 | 0.5723 |
| 129 | 1.5640 | 6.8233 | 0.8363 | 0.1226 | 0.5642 |
| 130 | 1.5583 | 5.2589 | 0.8061 | 0.1533 | 0.5778 |
| 131 | 1.7817 | 6.8233 | 0.8064 | 0.1182 | 0.5407 |

TABLE 4

| | Glass properties | | | | | | | | | |
|---|---|---|---|---|---|---|---|---|---|---|
| | | | | | | | specific | | | |
| No. | n_{d} | n_{C} | n_{F} | n_{g} | ν_{d} | T_{g}(° C.) | gravity | λ₈₀(nm) | λ₇₀(nm) | λ₅(nm) |
| 1 | 1.90735 | 1.89625 | 1.93524 | 1.95959 | 23.27 | 658.5 | 3.682 | 573 | 482 | 383 |
| 2 | 1.90670 | 1.89546 | 1.93493 | 1.95968 | 22.97 | 653.8 | 3.575 | 591 | 479 | 381 |
| 3 | 1.90747 | 1.89630 | 1.93555 | 1.96010 | 23.12 | 660.9 | 3.580 | 565 | 472 | 380 |
| 4 | 1.90792 | 1.89666 | 1.93618 | 1.96094 | 22.97 | 663.5 | 3.476 | 577 | 473 | 381 |
| 5 | 1.90685 | 1.89573 | 1.93482 | 1.95925 | 23.20 | 662.4 | 3.636 | 567 | 474 | 382 |
| 6 | 1.90658 | 1.89542 | 1.93463 | 1.95919 | 23.12 | 663.5 | 3.588 | 562 | 472 | 381 |
| 7 | 1.91281 | 1.90143 | 1.94149 | 1.96659 | 22.79 | 643.1 | 3.630 | 582 | 484 | 384 |
| 8 | 1.90529 | 1.89430 | 1.93293 | 1.95709 | 23.43 | 661.5 | 3.682 | 560 | 470 | 381 |
| 9 | 1.90389 | 1.89295 | 1.93135 | 1.95529 | 23.54 | 662.9 | 3.682 | 557 | 470 | 380 |
| 10 | 1.90671 | 1.89556 | 1.93471 | 1.95918 | 23.16 | 663.2 | 3.620 | 557 | 467 | 380 |
| 11 | 1.90659 | 1.89544 | 1.93463 | 1.95910 | 23.13 | 663.2 | 3.604 | 559 | 467 | 380 |
| 12 | 1.90615 | 1.89490 | 1.93446 | 1.95924 | 22.91 | 652.7 | 3.597 | 560 | 472 | 382 |
| 13 | 1.91386 | 1.90239 | 1.94274 | 1.96804 | 22.65 | 661.0 | 3.572 | 559 | 469 | 381 |
| 14 | 1.92107 | 1.90929 | 1.95080 | 1.97693 | 22.19 | 660.9 | 3.541 | 679 | 485 | 384 |
| 15 | 1.90529 | 1.89409 | 1.93347 | 1.95808 | 22.99 | 658.8 | 3.564 | 557 | 468 | 380 |
| 16 | 1.90381 | 1.89256 | 1.93209 | 1.95683 | 22.86 | 654.3 | 3.522 | 574 | 472 | 380 |
| 17 | 1.90653 | 1.89536 | 1.93463 | 1.93463 | 23.08 | 662.3 | 3.569 | 560 | 466 | 380 |
| 18 | 1.90699 | 1.89579 | 1.93518 | 1.95980 | 23.03 | 661.6 | 3.535 | 573 | 470 | 381 |
| 19 | 1.90495 | 1.90929 | 1.95080 | 1.97693 | 22.93 | 659.3 | 3.548 | 679 | 485 | 384 |
| 20 | 1.90631 | 1.89516 | 1.93439 | 1.95891 | 23.10 | 655.1 | 3.676 | 569 | 474 | 381 |
| 21 | 1.90236 | 1.89122 | 1.93039 | 1.95490 | 23.04 | 646.9 | 3.661 | 554 | 470 | 380 |
| 22 | 1.90200 | 1.89097 | 1.92976 | 1.95397 | 23.25 | 661.0 | 3.564 | 548 | 464 | 379 |
| 23 | 1.89907 | 1.88818 | 1.92642 | 1.95024 | 23.51 | 665.7 | 3.566 | 551 | 465 | 379 |
| 24 | 1.89601 | 1.88526 | 1.92297 | 1.94641 | 23.76 | 667.6 | 3.566 | 547 | 462 | 378 |
| 25 | 1.89965 | 1.88869 | 1.92718 | 1.95111 | 23.37 | 662.2 | 3.568 | 545 | 462 | 378 |
| 26 | 1.89423 | 1.88351 | 1.92108 | 1.94447 | 23.80 | 664.6 | 3.571 | 542 | 461 | 378 |
| 27 | 1.88891 | 1.87843 | 1.91516 | 1.93796 | 24.20 | 667.5 | 3.575 | 536 | 458 | 376 |
| 28 | 1.89805 | 1.88690 | 1.92610 | 1.95061 | 22.91 | 649.3 | 3.537 | 552 | 468 | 380 |
| 29 | 1.89080 | 1.87972 | 1.91871 | 1.94316 | 22.85 | 638.1 | 3.510 | 551 | 468 | 380 |
| 30 | 1.89830 | 1.88713 | 1.92640 | 1.95099 | 22.87 | 649.6 | 3.500 | 554 | 465 | 379 |
| 31 | 1.89099 | 1.87985 | 1.91902 | 1.94355 | 22.75 | 638.2 | 3.436 | N/A | 498 | 380 |
| 32 | 1.89628 | 1.88527 | 1.92392 | 1.94806 | 23.19 | 658.5 | 3.537 | 553 | 466 | 379 |
| 33 | 1.90230 | 1.89106 | 1.93059 | 1.95534 | 22.83 | 651.7 | 3.551 | 545 | 465 | 380 |
| 34 | 1.89899 | 1.88770 | 1.92739 | 1.95223 | 22.65 | 641.9 | 3.536 | 555 | 468 | 380 |
| 35 | 1.90280 | 1.89152 | 1.93116 | 1.95599 | 22.77 | 650.3 | 3.513 | 559 | 470 | 380 |
| 36 | 1.89992 | 1.88859 | 1.92848 | 1.95352 | 22.56 | 641.7 | 3.461 | 574 | 473 | 381 |
| 37 | 1.90098 | 1.88979 | 1.92908 | 1.95369 | 22.93 | 650.7 | 3.545 | 554 | 469 | 380 |
| 38 | 1.90435 | 1.89311 | 1.93255 | 1.95726 | 22.93 | 652.4 | 3.554 | 567 | 473 | 381 |
| 39 | 1.89976 | 1.88854 | 1.92802 | 1.95279 | 22.79 | 641.7 | 3.535 | 574 | 475 | 381 |
| 40 | 1.90135 | 1.89005 | 1.92984 | 1.95482 | 22.65 | 635.3 | 3.533 | 583 | 478 | 382 |
| 41 | 1.90143 | 1.89024 | 1.92957 | 1.95415 | 22.92 | 652.1 | 3.544 | 564 | 473 | 381 |
| 42 | 1.89965 | 1.88841 | 1.92794 | 1.95274 | 22.76 | 641.8 | 3.521 | 561 | 470 | 380 |
| 43 | 1.90103 | 1.88970 | 1.92957 | 1.95459 | 22.60 | 636.9 | 3.499 | 564 | 473 | 381 |
| 44 | 1.89954 | 1.88835 | 1.92763 | 1.95223 | 22.90 | 651.6 | 3.524 | 557 | 470 | 381 |
| 45 | 1.90142 | 1.89021 | 1.92962 | 1.95427 | 22.87 | 653.3 | 3.512 | 563 | 471 | 381 |
| 46 | 1.90516 | 1.89371 | 1.93402 | 1.95930 | 22.45 | — | 3.521 | 567 | 473 | 381 |
| 47 | 1.90495 | 1.89351 | 1.93376 | 1.95903 | 22.48 | — | 3.539 | 575 | 477 | 382 |
| 48 | 1.89983 | 1.88863 | 1.92803 | 1.95269 | 22.84 | — | 3.528 | 560 | 470 | 380 |
| 49 | 1.90203 | 1.89076 | 1.93041 | 1.95524 | 22.75 | — | 3.520 | N/A | 651 | 383 |
| 50 | 1.89995 | 1.88875 | 1.92873 | 1.95279 | 22.51 | — | 3.537 | 565 | 473 | 381 |
| 51 | 1.90215 | 1.89088 | 1.93049 | 1.95530 | 22.78 | — | 3.536 | 566 | 475 | 382 |
| 52 | 1.90778 | 1.89637 | 1.93654 | 1.96170 | 22.60 | 632.0 | 3.553 | N/A | 519 | 381 |
| 53 | 1.90292 | 1.89164 | 1.93133 | 1.95616 | 22.75 | 638.3 | 3.543 | 564 | 473 | 381 |
| 54 | 1.89317 | 1.88215 | 1.92085 | 1.94505 | 23.08 | 657.2 | 3.530 | 556 | 467 | 379 |
| 55 | 1.88751 | 1.87766 | 1.91481 | 1.93864 | 23.89 | 668.4 | 3.518 | 557 | 466 | 379 |
| 56 | 1.89949 | 1.88825 | 1.92776 | 1.95252 | 22.77 | 647.7 | 3.529 | 555 | 468 | 380 |
| 57 | 1.90115 | 1.88982 | 1.92970 | 1.95473 | 22.60 | 646.3 | 3.521 | 559 | 471 | 381 |
| 58 | 1.89942 | 1.88821 | 1.92765 | 1.95237 | 22.80 | 646.5 | 3.536 | 554 | 468 | 380 |
| 59 | 1.90097 | 1.88968 | 1.92939 | 1.95433 | 22.69 | 644.8 | 3.536 | 554 | 469 | 380 |
| 60 | 1.90383 | 1.89252 | 1.93226 | 1.95721 | 22.74 | 650.0 | 3.544 | 588 | 476 | 381 |
| 61 | 1.89922 | 1.88805 | 1.92738 | 1.95196 | 22.86 | 646.1 | 3.539 | 555 | 467 | 380 |
| 62 | 1.90066 | 1.88944 | 1.92889 | 1.95357 | 22.83 | 645.2 | 3.542 | 563 | 473 | 380 |
| 63 | 1.90497 | 1.89366 | 1.93345 | 1.95838 | 22.74 | 635.6 | 3.557 | 562 | 474 | 381 |
| 64 | 1.92268 | 1.91165 | 1.95028 | 1.97425 | 23.89 | 629.3 | 3.836 | 547 | 456 | 374 |
| 65 | 1.90417 | 1.89299 | 1.93226 | 1.9568 | 23.02 | 659.9 | 3.564 | 564 | 469 | 381 |
| 66 | 1.90306 | 1.89192 | 1.93106 | 1.95554 | 23.07 | 660 | 3.565 | 563 | 470 | 381 |
| 67 | 1.90183 | 1.89073 | 1.92975 | 1.95415 | 23.11 | 658.4 | 3.564 | 556 | 469 | 381 |
| 68 | 1.90074 | 1.88966 | 1.92857 | 1.95291 | 23.15 | 656.9 | 3.564 | 561 | 471 | 381 |
| 69 | 1.90803 | 1.8968 | 1.93627 | 1.96093 | 23.01 | 657.1 | 3.576 | 571 | 470 | 380 |
| 70 | 1.91074 | 1.89947 | 1.93906 | 1.9638 | 23 | 659.1 | 3.586 | 575 | 475 | 380 |
| 71 | 1.90806 | 1.89686 | 1.93623 | 1.96084 | 23.06 | 658.7 | 3.577 | 558 | 470 | 380 |
| 72 | 1.91046 | 1.89924 | 1.93861 | 1.96319 | 23.13 | 654.9 | 3.588 | 558 | 470 | 380 |
| 73 | 1.90209 | 1.89103 | 1.92986 | 1.95411 | 23.23 | 662.1 | 3.562 | 554 | 468 | 380 |
| 74 | 1.9022 | 1.89113 | 1.92999 | 1.95429 | 23.22 | 660 | 3.557 | 555 | 468 | 380 |
| 75 | 1.90238 | 1.8913 | 1.93024 | 1.95456 | 23.17 | 659.5 | 3.552 | 555 | 467 | 379 |
| 76 | 1.90208 | 1.891 | 1.92992 | 1.95425 | 23.18 | 660.6 | 3.547 | 561 | 468 | 379 |
| 77 | 1.90481 | 1.89352 | 1.93322 | 1.95811 | 22.79 | 641.9 | 3.551 | 560 | 472 | 381 |
| 78 | 1.90669 | 1.89539 | 1.93516 | 1.96007 | 22.8 | 646 | 3.558 | 569 | 476 | 381 |
| 79 | 1.90843 | 1.8971 | 1.9369 | 1.96183 | 22.82 | 637.5 | 3.559 | 566 | 475 | 381 |
| 80 | 1.91019 | 1.89885 | 1.93869 | 1.96363 | 22.85 | 639.6 | 3.567 | 566 | 475 | 381 |
| 81 | 1.90046 | 1.88924 | 1.92872 | 1.95346 | 22.81 | 645.8 | 3.534 | 626 | 498 | 380 |
| 82 | 1.90036 | 1.88911 | 1.92865 | 1.95343 | 22.77 | 644.6 | 3.526 | 620 | 497 | 380 |
| 83 | 1.90367 | 1.89239 | 1.93204 | 1.95689 | 22.79 | 637.6 | 3.547 | 609 | 488 | 378 |
| 84 | 1.9064 | 1.89508 | 1.93492 | 1.95986 | 22.75 | 631.8 | 3.551 | 621 | 493 | 378 |
| 85 | 1.90909 | 1.89771 | 1.9377 | 1.96283 | 22.73 | 628.4 | 3.556 | 641 | 506 | 379 |
| 86 | 1.91114 | 1.89974 | 1.93987 | 1.96503 | 22.7 | 625.4 | 3.557 | 623 | 497 | 379 |
| 87 | 1.90026 | 1.88909 | 1.92841 | 1.95302 | 22.9 | 629.9 | 3.555 | 559 | 470 | 380 |
| 88 | 1.90049 | 1.8893 | 1.92859 | 1.95319 | 22.92 | 630.5 | 3.568 | 561 | 472 | 380 |
| 89 | 1.90057 | 1.8894 | 1.92864 | 1.95321 | 22.95 | 631.5 | 3.584 | 567 | 474 | 380 |
| 90 | 1.90031 | 1.88912 | 1.92843 | 1.95305 | 22.9 | 630.6 | 3.572 | 568 | 475 | 381 |
| 91 | 1.90028 | 1.88915 | 1.92828 | 1.95277 | 23.01 | 631.1 | 3.638 | 558 | 474 | 381 |
| 92 | 1.90025 | 1.88906 | 1.92844 | 1.95308 | 22.86 | 629.1 | 3.555 | 599 | 485 | 381 |
| 93 | 1.90009 | 1.88891 | 1.92821 | 1.95286 | 22.9 | 637.2 | 3.573 | 560 | 470 | 380 |
| 94 | 1.90161 | 1.89044 | 1.92969 | 1.95429 | 22.97 | 634.1 | 3.558 | 556 | 469 | 380 |
| 95 | 1.90293 | 1.89179 | 1.93095 | 1.95544 | 23.06 | 646.6 | 3.581 | 554 | 468 | 380 |
| 96 | 1.90163 | 1.89047 | 1.92961 | 1.95409 | 23.04 | 640 | 3.552 | 560 | 470 | 380 |
| 97 | 1.90258 | 1.89151 | 1.93034 | 1.9546 | 23.24 | 644.6 | 3.568 | 561 | 469 | 380 |
| 98 | 1.90131 | 1.89017 | 1.92925 | 1.95371 | 23.06 | 634.9 | 3.567 | 560 | 469 | 380 |
| 99 | 1.90134 | 1.8903 | 1.92914 | 1.95337 | 23.21 | 615.5 | 3.593 | 550 | 469 | 379 |
| 100 | 1.90319 | 1.89209 | 1.93108 | 1.95546 | 23.16 | 626.6 | 3.591 | 556 | 470 | 379 |
| 101 | 1.90402 | 1.89292 | 1.9319 | 1.95628 | 23.19 | 623.4 | 3.585 | 555 | 470 | 379 |
| 102 | 1.90015 | 1.88905 | 1.92796 | 1.95233 | 23.13 | 620 | 3.583 | 557 | 469 | 379 |
| 103 | 1.89932 | 1.88827 | 1.92711 | 1.95142 | 23.15 | 634.3 | 3.579 | 567 | 472 | 380 |
| 104 | 1.89882 | 1.88785 | 1.92638 | 1.9504 | 23.33 | 634.5 | 3.584 | 555 | 466 | 379 |
| 105 | 1.90024 | 1.88929 | 1.92772 | 1.95169 | 23.43 | 644 | 3.591 | 551 | 465 | 379 |
| 106 | 1.8984 | 1.8874 | 1.92566 | 1.9495 | 23.21 | 626.1 | 3.594 | 588 | 473 | 378 |
| 107 | 1.90003 | 1.88903 | 1.92766 | 1.95181 | 23.3 | 623.6 | 3.587 | 553 | 466 | 379 |
| 108 | 1.90037 | 1.88929 | 1.92821 | 1.95254 | 23.13 | 616.6 | 3.539 | 548 | 466 | 379 |
| 109 | 1.90056 | 1.88963 | 1.92797 | 1.95188 | 23.49 | 617.9 | 3.611 | 562 | 468 | 378 |
| 110 | 1.9006 | 1.88968 | 1.92797 | 1.95185 | 23.52 | 622.2 | 3.615 | 553 | 468 | 379 |
| 111 | 1.90038 | 1.88955 | 1.92754 | 1.9512 | 23.7 | 617 | 3.625 | 552 | 467 | 378 |
| 112 | 1.90205 | 1.89112 | 1.92945 | 1.95342 | 23.53 | 618.9 | 3.611 | 553 | 466 | 378 |
| 113 | 1.89907 | 1.88816 | 1.92652 | 1.95045 | 23.44 | 618.5 | 3.599 | 548 | 465 | 378 |
| 114 | 1.90007 | 1.88911 | 1.92761 | 1.95167 | 23.38 | 621.4 | 3.619 | 556 | 465 | 378 |
| 115 | 1.90017 | 1.88918 | 1.92776 | 1.95186 | 23.33 | 626.7 | 3.613 | 554 | 466 | 378 |
| 116 | 1.89999 | 1.88905 | 1.92773 | 1.95189 | 23.28 | 620.4 | 3.603 | 560 | 469 | 379 |
| 117 | 1.89995 | 1.88902 | 1.92779 | 1.952 | 23.23 | 621 | 3.595 | 564 | 471 | 379 |
| 118 | 1.90119 | 1.89002 | 1.92867 | 1.95286 | 23.5 | 624 | 3.592 | 550 | 466 | 378 |
| 119 | 1.90169 | 1.89101 | 1.92968 | 1.95391 | 23.71 | 624.5 | 3.594 | 553 | 468 | 379 |
| 120 | 1.90249 | 1.892 | 1.93069 | 1.95496 | 23.92 | 627.3 | 3.595 | 570 | 474 | 379 |
| 121 | 1.90313 | 1.89299 | 1.9317 | 1.95601 | 24.13 | 637 | 3.597 | 575 | 475 | 380 |
| 122 | 1.90165 | 1.89109 | 1.92963 | 1.95377 | 23.58 | 621.2 | 3.625 | 582 | 471 | 378 |
| 123 | 1.90174 | 1.89076 | 1.92929 | 1.95336 | 23.4 | 624 | 3.633 | 565 | 470 | 379 |
| 124 | 1.90173 | 1.89113 | 1.92961 | 1.9537 | 23.59 | 632.7 | 3.638 | 582 | 473 | 379 |
| 125 | 1.90173 | 1.89073 | 1.92935 | 1.95347 | 23.35 | 621.2 | 3.627 | 558 | 469 | 379 |
| 126 | 1.9017 | 1.8907 | 1.92941 | 1.95358 | 23.33 | 620.8 | 3.621 | 582 | 474 | 379 |
| 127 | 1.90098 | 1.88985 | 1.92914 | 1.95373 | 22.88 | 633.1 | 3.591 | 551 | 466 | 379 |
| 128 | 1.90075 | 1.88977 | 1.92837 | 1.95251 | 23.34 | 617.4 | 3.617 | 546 | 463 | 378 |
| 129 | 1.90088 | 1.88977 | 1.92880 | 1.95322 | 23.082 | 622.1 | 3.598 | 550 | 466 | 379 |
| 130 | 1.90168 | 1.8906 | 1.92954 | 1.9539 | 23.16 | 631.6 | 3.61 | 556 | 469 | 379 |
| 131 | 1.89886 | 1.88769 | 1.92696 | 1.9515 | 22.89 | 609.3 | 3.619 | 552 | 468 | 379 |

### Example 2

Lens blanks were produced by a known method using each of the optical glasses produced in Example 1, and the lens blanks were processed by a known method such as polishing to produce various lenses.

The produced optical lenses are various lenses such as a flat lens, a biconvex lens, a biconcave lens, a plano-convex lens, a plano-concave lens, a concave meniscus lens, and a convex meniscus lens. Here, members obtained by cutting the optical glass without heating and softening the optical glass can also be used as lens blanks. In addition, prisms were also produced by a known method using each of the optical glasses produced in Example 1.

Furthermore, light guide plates for use in an augmented reality display device such as a wearable display were produced by a known method using each of the optical glasses produced in Example 1.

Since the glass had a low specific gravity, the produced light guide plates were lighter in weight than light guide plates with equivalent optical properties and size, and were suitable as light guide plates for use in an augmented reality display device such as a wearable display.

The embodiment disclosed herein should be considered as illustrative and not restrictive in all respects. The scope of the present invention is defined not by the above description but by the claims, and is intended to include all modifications within the concept and scope equivalent to the claims.

For example, the optical glass according to one aspect of the present invention can be produced by performing composition adjustment described in the specification on the glass composition illustrated above.

In addition, two or more of the items illustrated in the specification or described as preferred ranges can, of course, be arbitrarily combined.

What is claimed is:

1. An optical glass,
wherein an amount of SiO₂ is 5% by mass or more,
an amount of B₂O₃ is 15% by mass or less,
a total amount of Li₂O, Na₂O, and K₂O [Li₂O+Na₂O+K₂O] is 1 to 15% by mass,
a mass ratio of an amount of Li₂O to the total amount of Li₂O, Na₂O, and K₂O [Li₂O/(Li₂O+Na₂O+K₂O)] is 0.5 or less,
a mass ratio of an amount of K₂O to the total amount of Li₂O, Na₂O, and K₂O [K₂O/(Li₂O+Na₂O+K₂O)] is 0.5 or less,
a mass ratio of the total amount of Li₂O, Na₂O, and K₂O to a total amount of MgO, CaO, SrO, and BaO [(Li₂O+Na₂O+K₂O)/(MgO+CaO+SrO+BaO)] is 0.6 or less,
an amount of TiO₂ is 15% by mass or more,
an amount of Nb₂O₅ is 1 to 30% by mass,
a mass ratio of the amount of SiO₂ to the amount of TiO₂ [SiO₂/TiO₂] is 1.0 or less,
the total amount of MgO, CaO, SrO, and BaO [MgO+CaO+SrO+BaO] is 5% by mass or more,
a mass ratio of an amount of BaO to the total amount of MgO, CaO, SrO, and BaO [BaO/(MgO+CaO+SrO+BaO)] is 0.7 or less,
a total amount of TiO₂ and Nb₂O₅ [TiO₂+Nb₂O₅] is 30% by mass or more, and
a mass ratio of the amount of TiO₂ to a total amount of TiO₂, Nb₂O₅, Y₂O₃, ZrO₂, La₂O₃, Gd₂O₃, Ta₂O₅, WO₃, Yb₂O₃, and Bi₂O₃ [TiO₂/(TiO₂+Nb₂O₅+Y₂O₃+ZrO₂+La₂O₃+Gd₂O₃+Ta₂O₅+WO₃+Yb₂O₃+Bi₂O₃)] is 0.6 or more.

2. An optical element comprising the optical glass according to claim 1.

3. A light guide plate comprising the optical glass according to claim 1.
